(19) United States
(12) Patent Application Publication
(10) Pub. No.: US 2004/0023829 A1
(43) Pub. Date: Feb. 5, 2004

(54) Compositions comprising fabric softener actives having certain ratios of mono-tail to di-tail groups

(75) Inventor: Gayle Marie Frankenbach, Cincinnati, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Co.

(21) Appl. No.: 10/461,710

(22) Filed: Jun. 13, 2003

Related U.S. Application Data
(60) Provisional application No. 60/388,324, filed on Jun. 13, 2002.

(51) Int. Cl. C11D 3/00

(52) U.S. Cl. 510/327; 510/515

(57) ABSTRACT

Optimal highly fluid fabric softener actives comprising an optimal ratio of mono-tail to di-tail species. Viscosity stable concentrated fabric softener compositions containing a fabric softener active system wherein the fabric softener active system comprises at least about 5% of an optimal highly-fluid fabric softener active such of the present invention.

### CROSS REFERENCE TO RELATED APPLICATIONS

This application claims priority under 35 U.S.C. § 119(e) to U. S. Provisional Application Serial No. 60/388,324, filed Jun. 13, 2002 (Attorney Docket No.8973P).

### TECHNICAL FIELD

The present invention relates to a highly fluid fabric softener active material comprising a divalent linkage and an optimal level of a mono-tail side product as well as concentrated aqueous textile treatment compositions comprising said highly fluid actives. In particular, said highly fluid fabric softener actives are useful in making concentrated compositions that have improved non-ambient stability and improved perfume incorporation as well as delivering color care, improved wrinkle control, and improved absorbency.

### BACKGROUND OF THE INVENTION

Aqueous textile treatment compositions suitable for providing fabric softening and static control benefits during laundering are well-known in the art and have found wide-scale commercial application. Conventionally, aqueous, rinse-added, fabric softening compositions contain, as the active softening component, substantially water-insoluble cationic materials having two long alkyl chains. Typical of such materials are di-tail fabric softener actives that are completely or partially saturated and comprise a divalent linkage such as hard-tallow DEEDMAC, soft-tallow DEEDMAC, Varisoft 110, or Varisoft 222. Such fabric softener actives are defined herein as actives with low or medium fluidity. These materials are normally easily prepared in the form of a dispersion in water. Fabric softener materials that are less typically used to prepare dispersions are fabric softener actives having a divalent linkage that are highly fluid due to high unsaturation. It is desireable to be able to use such highly unsaturated, highly fluid fabric softener actives in dispersions because these materials impart improved absorbency, improved color care, and improved wrinkle control. However it is difficult to form dispersions comprising highly unsaturated highly fluid actives and to incorporate perfume into such dispersions. Now it is surprising discovered that highly saturated di-tail fabric softener actives that comprise an optimal level of a mono-tail side product can be used to produce dispersions with improved stability in dispersions containing about 10% fabric softener active. Additionally, an optimal level of mono-tail side product aids in incorporating perfume into dispersions comprising highly fluid fabric softener actives. It is further found that fabric softener actives comprising an optimal level of the mono-tail side product have improve perfume incorporation.

Many of the various solutions to the specific problem of preparing aqueous fabric softening compositions, especially in concentrated form suitable for consumer use, have not been entirely satisfactory. For example, in U.S. Pat. No. 3,681,241, the presence of ionizable salts in softener compositions tend to help reduce viscosity, but this approach by itself is ineffective in preparing compositions containing more than about 12% of dispersed softener, inasmuch as the level of ionizable salts necessary to reduce viscosity to any substantial degree has a seriously detrimental effect on product viscosity stability.

U.S. Pat. Nos. 5,877,145 and 5,759,990, (Wahl et al.) and U.S. Pat. No. 5,830,845 (Trinh et al.) all disclose improved freeze-thaw stability for highly unsaturated biodegradeable fabric softener active.

It is now found that using fabric softener active comprising an optimal level of the mono-tail side product it is possible to maintain stable compositions comprising highly fluid fabric softener actives at non-ambient temperatures and under muliple freeze-thaw cycles.

### SUMMARY OF THE INVENTION

Now it is surprisingly discovered that by using optimal highly fluid fabric softener actives comprising an optimal level of mono-tail side products, it is possible to form highly concentrated fabric softener dispersions that deliver improved beneftis such as better dispersibility, and improved perfume incorporation together with benefits such as wrinkle reduction improved color care, increased absorbency etc. Suprisingly it is now also found that it is possible to fomulate very stable concentrated systems comprising optimal highly fluid fabric softener actives, e.g. systems having desireably long-term viscosity characteristics at non-ambient temperatures by using highly fluid fabric softener actives comprising an optimal level of a mono-tail side product

The highly fluid fabric softerner actives of the are those comprising an optimal level of a mono-tail side product. An optimal level of a mono-tail side product is defined in terms of the ratio between the amount of di-tial fabric softener active to mono-tail side product. A preferable range for the di-tail to mono-tail ratio is from about 1 to 1 up to about 1 to 15, more preferably it is from about 1 to 2 up to about 1 to 10 and most preferably it is from about 1 to 3 up to about 1 to 6.

The concentrated liquid fabric softening compositions of the present invention comprise essentially

(A) at least about 10% of a fabric softener active system wherein the said fabric softener active system comprises at least about 5% of an optimal highly fluid fabric softener active having an optimal level of a mono-tail side product;

(B) a fluid medium, typically aqueous-based, to act as a continuous phase for the formation of a dispersion; and

(C) optionally, the fabric softener active system comprises an adjunct fabric softener active when the fabric softener system does not comprise 100% of a the optimal highly-fluid fabric softener active.

(D) optional ingredients

The composition comprises from about 10% to about 95% by weight of the composition of the fabric softener active system wherein the said fabric softener active system comprises at least about 5% of a highly fluid fabric softener active having an optimal level of mono-tail side product.

All documents cited herein are, in relevant part, incorporated herein by reference; the citation of any document is not to be construed as an admission that it is prior art with respect to the present invention.

It should be understood that every maximum numerical limitation given throughout this specification will include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All parts, ratios, and percentages herein, in the Specification, Examples, and Claims, are by weight and all numerical limits are used with the normal degree of accuracy afforded by the art, unless otherwise specified.

### DETAILED DESCRIPTION OF THE INVENTION

### I. Compound: Optimal Highly-Fluid Fabric Softener Active

The compound of the present invention, is an optimal highly-fluid fabric softener active comprising an amine-based head group and hydrophobic tails with chain interrupters in the hydrophobic tails. The optimal highly-fluid fabric softener active of the present composition comprises a mono-tail material that is a side-product of the reaction to prepare a di-tail material. The mono-tail material is present at an optmal level in relation to the di-tail material. Preferably the monotail to di-tail ratio is a range between about 1:1 up to about 1:15, more preferably between about 1:2 up to about 1:10, and most preferably between about 1:3 and up to about 1:6. While it is acceptable for the optimal highly-fluid fabric softener active to comprise tri-tail structures, this is not preferred.

Acceptable structures for the optimal highly-fluid fabric softener active of the present invention are disclosed below.

Preferred fabric softener actives are hydrophobic quateranary ammonium compounds having chain interrupters (which are designated “Y” herein below). In more preferred structures, the chain interrupters is capable of hydrolytic cleavage. The proclivity for hydrolytic cleavage is especially preferred when the fabric softener actives are used in applications requiring biodegradeably species. Several general structures for hydrophobic quaternary ammonium compounds wherein the hydrophobes have chain interrupters are detailed below:

{R₄₋ₘ—N⁺—[(CH₂)ₙ—Y—R¹]ₘ}X⁻ i

wherein each R substituent is either hydrogen, a small hydrocarbon or substituted hydrocabon comprising one to about six carbons with some nonlimiting examples including., methyl, ethyl, propyl, hydroxyethyl, and the like, poly (C₂₋₃ alkoxy) , benzyl, or mixtures thereof; each m is 2 or 3; each n is from 1 to about 4, preferably 2; each Y is a hydrocarbon chain interrupter, including, but not limited to —O—, —N—, —O—(O)C—, —C(O)—O—, —NR—C(O)—, or —C(O)—NR—; each Y can be the same or different the sum of carbons in each R¹, plus one when Y contains one carbon, is about C₈ to about C₂₂, preferably about C₁₄ to about C₂₀, with each R¹ being a hydrocarbyl, or substituted hydrocarbyl group, it is acceptable for R¹ to be saturated, unsaturated, branched, linear, cyclic, or combinations thereof, each R¹ can be the same or different

[R₃N⁺CH₂CH(YR¹)(CH₂YR¹)]X⁻ ii

wherein each Y, R, and R¹have the same meanings as before. Such compounds include those having the formula:

[CH₃]₃N⁽⁺⁾[CH₂CH(CH₂O(O)CR¹)O(O)CR¹]⁻C1⁽⁻⁾

wherein each R is a methyl or ethyl group and preferably each R¹ is in the range of about C₇ to about C₂₁. As used herein, when the diester is specified, it can include the monoester that is present.

A preferred embodiment of the hydrophobic quaternary ammonium compound is one in which Y is an ester linkage. Such compounds can be prepared by standard reaction chemistry utilizing fatty acids and amino alcohols followed by quaternization with alkylating agents or pH adjustment.

These types of agents and general methods of making them are disclosed in U.S. Pat. No. 4,137,180, Naik et al., issued Jan. 30, 1979, which is incorporated herein by reference.

Hydrophobic quaternary ammonium compounds with ester linkages herein can also contain a low level of fatty acid, which can be from unreacted starting material used to form the ammonium ester and/or as a by-product of any partial degradation (hydrolysis) of the softener active in the finished composition. It is preferred that the level of free fatty acid be low, preferably below about 15%, more preferably below about 10%, and even more preferably below about 5%, by weight of the softener active.

The degree of fluidity of the fabric softener active is determined using DSC and the table below exemplifies how DSC is used to classify fabric softeners with linear hydrophobes having different levels of unsaturation into low, mid, and high fluid categories.

| Quat | Fluidity | DSC Trace | Graph⁷ |
|---|---|---|---|
| 1 | Low | peak onset is about 65° C. | 1A |
| | | transition end is about 45° C. | |
| 2 | Low | peak onset is about 58° C. | 1B |
| | | transition end is about 20° C. | |
| 3 | Medium | peak on set is about 45° C. | 1C |
| | | transition end is about 10° C. | |
| 4 | Medium | peak on set is about 30° C. | 1D |
| | | transition end is about 5° C. | |
| 5 | High | peak on set is about 12° C. | 1E |
| | | transition end is below 0° C. | |
| 6 | High | peak on set is about −3° C. | 1F |
| | | transition end is below −10° C. | |

1. Hard tallow DEEDMAC - ditallowoylethylester dimethyl ammonium chloride, IV = about 10.
2. Varisoft 110 - methyl bis(tallowamidoethyl)-2-hydroxyethyl anmonium methyl sulfate, IV = about 10.
3. Soft tallow DEEDMAC -ditallowoylethylester dimethyl ammonium chloride, IV = about 50.
4. Varisoft 222 - methyl bis(tallowamidoethyl)-2-hydroxyethyl ammonium methyl sulfate, IV = about 50.
5. Canola DEEDMAC - dicanola-ethylester dimethyl ammonium chloride.
6. Methyl bis(canola-amidoethyl)-2-hydroxyethyl ammonium methyl sulfate.
DSC data is taken from graphs in Example 1 according to the reference key given in the table.

In addition to the formulation benefits (viscosity stability, perfume incorporation, et al.) presented by the mono-tail species which is present as an essential component in the optimal highly-fluid fabric softener active, the mono-tail species provides other benefits as well when the optimal high-fluid fabric softener material is incorporated into a composition. Mono-tail side-products are useful for imparting improved softness and wrinkle for complexing residual anionic surfactant, a material that is often carried over into the rinse from the detergent used in the wash cycle. In this way, the mono-tail material acts as a sacrificial material to protect the di-tail materials, that provide higher fabric care performance, from being precipitated in the rinse by complexation with residual anionic surfactant.

### II. Composition

The compositions of the present invention essentially comprise an fabric softener active system wherein the said fabric softener active system contains about 20% of a optimal highly fluid fabric softener active. The compositions comprise from about 10% to about 95% of a fabric softener active system

(A). The Optimal Highly Fluid Fabric Softener Active

The optimal highly-fluid fabric softener active is describe above. The composition described herein comprises a fabric softener active system composed of at least about 20% of an optimal highly-fluid fabric softener active.

A variety of benefits are derived by incorporating highly fluid fabric softeners active into the fabric softener active system including but not limited to: 1) improvements in absorbency, 2) improvements in dispersibility and uniform coverage, 3) improvements in color care, and 4) improvements in wrinkle control. These benefits are described in further detail below. However, the incoporation of highly fluid actives presents challenges related to product stability with respect to maintaining stable low viscosities when materials are stored at non-ambient temperatures conditions and then re-equilibrated to ambient conditions as could happen during shipping or as consumers transport and store products. Incorporating highly fluid fabric softener actives can also lead to product splitting. Finally, it is typically difficult to incorporate perfumes into compositions comprising highly-fluid fabric softener actives leading to poor aesthetic performance and thus poor consumer acceptance. By using optimal highly-fluid fabric softener actives with optimal mono-tail to di-tail ratios in the compositions the negative aspects of using highly-fluid fabric softener actives can be eliminated, such that the benefits of highly fluid fabric softener actives can be offered in a composition that is acceptable for consumer use.

The Benefits Dervied from the Presence of More Fluid Fabric Softener Active are Described in Detail Herein Below.

1. Improvements in Absorbency

Typical fabric softener compositions are known to result in reduction of absorbency of fabrics that are naturally absorbent even when the fabric softener is used for as little as one cycle. Over multi-cycle usage, the lack of absobency becomes exacerbated. An exception to this behavior is seen with fabric softener systems that distributed poorly and thus spread non-uniformly over fabrics. In cases where fabric softener actives are spread non-uniformly over fabrics, the absorbency of the fabric is maintained, but at the cost of poor performance in softenening and other aspects that the fabric softener is expected to deliver. When dispersion compositions comprise highly fluid actives absorbency is maintained together even distribution of active over the fabric surface. Not to be bound by theory but when fluid actives are deposited on fabrics, the fluidity of these materials is such that the deposited materials are capable of moving aside to allow water to pass into the fabric. Alternately, it is also possible that these more fluid actives maintain a liquid crystalline structure upon deposition such that the ordered head groups can act as capillaries that transport water into the fabric.

2. Improvements in Color Care

While some typical fabric softeners dipsersions are know to provide benefits in color care, compositions of the present invention based on medium to high fluid actives can provide increases in color care. Not to be bound by theory, when fabric softener active systems comprise actives that have high fluidity tend to spread more effecitvely over fibriles, fibers, and yarns vs. low fluid fabric softener actives. Medium to high fluidity materials also have higher lubricity capacity vs. low fluid actives. By spreading more effectively over fibrils, fibers, and yarns, and more effectively lubricating fibrils, fabrics, and yarns, fabric softener active systems that comprise highly fluid actives protect the fabric structure from damage due to abrasion. Not to be bound by theory, but when abrasion occurs, this can lead to visible pilling which diffuses light reflected off fabric resulting in a perceived reduction in color richness. Compositions that comprise highly fluid actives can also reattach fibrils that are seperating from fibers, thus helping to prevent the formation of pills. Finally compositions that comprise highly fluid fabric softener actives can reduce light diffusion at the surface by better matching the refractive index between the surface and the air, thus providing a deepening of the apparent color. Generally, the higher the % of highly fluid fabric softener active present in compositions of present invention, the greater the color care provided by the composition.

3. Improvements in Wrinkle Control

Mechanisms associated with highly fluid fabric softener actives leading to improved lubricity disclosed above in section 1d. Improvements in Color Care also provide improvements in wrinkle control. Improving the lubricity of fibrils, fibers, and yarns leads to reduction in friction between the structures and thus eases the release of wrinkles in the fabric. Additionally, improved lubricity leads to reduced effort expended in ironing reduing both the time and work involved on the part of the consumer to remove wrinkles by ironing. In general, wrinkle control benefits are greater when the compositions of the present invention comprise a greater % of highly fluid fabric softener actives.

(B) Liquid Carrier

The compositions of the present invention herein comprise from about 5% to about 90%, preferably from about 20% to about 80% of an aqueous liquid carrier. The preferred aqueous carrier is water which can contain minor ingredients.

(C). The Optional Adjunct Fabric Softener Active System

The optional adjunct fabric softener active of the present invention comprises at least one nitrogen moiety (typically amine or ammonium) together with hydrophobic substituents also termed hydrophobes. The hydrophobes are typically, but not exclusively hydrocarbon-based compounds. Preferred adjunct fabric softener actives have at least two hydrophobes comprising at least about eight carbons and less than about 30 carbons. However, it is acceptable for the adjunct fabric softener actives to comprise multiple nitrogen-based species with differing numbers of hydrocarbon substituents.

It is acceptable for the hydrophobes to be saturated, unsaturated, branched, cyclic, linear, or any combination thereof. Acceptable hydrophobes, while typically and preferably hydrocabon-based may also be based on fluorocarbons or silicone compounds. It is acceptable for hydrocabon hydrophobes to be comprised entirely of carbon and hydrogen or for the hydrophobes to comprise non-carbon moieties, especially those based on nitrogen, oxygen, sulfur or phosphorous. Hydrophobes may be identical or different. needed to provide improved viscosity stability, improved perfume incorporation, and improved dispersibility. Secondarily mono-tail side-products can also be useful for imparting for complexing residual anionic surfactant, a material that is often carried over into the rinse from the detergent used in the wash cycle. In this way, the mono-tail material acts as a sacrificial material to protect the di-tail materials, that provide higher fabric care performance, from being precipitated in the rinse by complexation with residual anionic surfactant. Some side products may also be useful for adjusting the fluidity of the mixture.

a). Hydrophobic Quaternary Ammonium Compounds Without Chain Interrupters

Hydrophobic quaternary ammonium compounds without chain interrupters are also acceptable, but less prefferred especially where hydrolytic degradation of the active is desired for purposes such as biodegradability. Such materials have the following general formula:

[R₄₋ₘ—N⁽⁺⁾—R¹ₘ] A⁻

wherein each m is 2 or 3, each R¹ is a C₆-C₂₂, preferably C₁₄-C₂₀, wherein each R¹ is the same or different and it is acceptable for R¹ to be linear, branched, cyclic, acyclic, saturated, and/or unsaturated.

b) Adjunct Fabric Softener Actives with Cyclic Amine or Ammonium Compounds.

Cyclic amine or ammonium compoudns are acceptable as fabric softener active materials in the present invention. A variety of general formulas for compound with cyclic amine or ammonium compounds are disclosed below.

1) Imidazolinium Compounds:

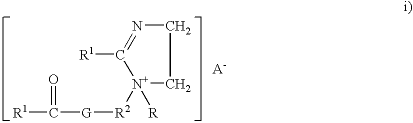

wherein each R, R¹, and A⁻ have the definitions given above; each R² is a C₁₋₆ alkylene group, preferably an ethylene group; and G is equivalent to Y disclosed above;

and:

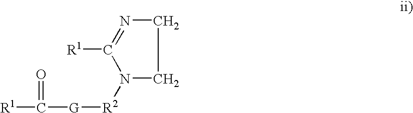

wherein R¹, R² and G are defined as above; and:

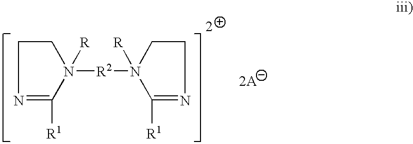

wherein R, R¹, R², and A⁻ are defined as above; and

iv) substituted imidazolinium salts having the formula:

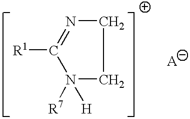

wherein R⁷ is hydrogen or a C₁-C₄ saturated alkyl or hydroxyalkyl group, and R¹ and A⁻ are defined as hereinabove;

v) substituted imidazolinium salts having the formula:

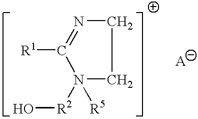

wherein R⁵ is a C₁-C₄ alkyl or hydroxyalkyl group, and R¹, R², and A⁻ are as defined above;

2) alkylpyridinium salts having the general formulas disclosed below:

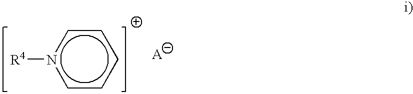

wherein R⁴ is an acyclic aliphatic C₈-C₂₂ hydrocarbon group and A⁻ is an anion; and

ii) alkanamide alkylene pyridinium salts having the formula:

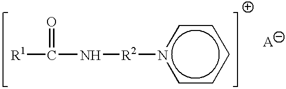

wherein R¹, R² and A⁻ are defined as herein above; and mixtures thereof.

Additional fabric softeners that can be used herein are disclosed, at least generically for the basic structures, in U.S. Pat. No. 3,861,870, Edwards and Diehl; U.S. Pat. No. 4,308,151, Cambre; U.S. Pat. Nop3,886,075, Bernardino; 4,233,164, Davis; 4,401,578, Verbruggen; 3,974,076, Wiersema and Rieke; and 4,237,016, Rudkin, Clint, and Young, all of said patents being incorporated herein by reference. The additional softener actives herein are preferably those that are highly unsaturated versions of the traditional softener actives, i.e., di-long chain alkyl nitrogen derivatives, normally cationic materials, such as dioleyldimethylammonium chloride and imidazolinium compounds as described hereinafter. Examples of more biodegradable fabric softeners can be found in U.S. Pat. No. 3,408,361, Mannheimer, issued Oct. 29, 1968; U.S. Pat. No. 4,709,045, Kubo et al., issued Nov. 24, 1987; U.S. Pat. No. 4,233,451, Pracht et al., issued Nov. 11, 1980; U.S. Pat. No. 4,127,489, Pracht et al., issued Nov. 28, 1979; U.S. Pat. No. 3,689,424, Berg et al., issued Sep. 5, 1972; U.S. Pat. No. 4,128,485, Baumann et al., issued Dec. 5, 1978; U.S. Pat. No. 4,161,604, Elster et al., issued Jul. 17, 1979; U.S. Pat. No. 4,189,593, Wechsler et al., issued Feb. 19, 1980; and U.S. Pat. No. 4,339,391, Hoffman et al., issued Jul. 13, 1982, said patents being incorporated herein by reference.

c) Additional Adjunct Fabric Softener Actives

Additional suitable fabric softerner structures are included by reference herein.

1) Polyhydroxy Materials and Sugar Derivatives

Polyhydroxy amide structures as disclosed in U.S. Pat. No. 5,534,197 by Scheibel et al. and U.S. Pat. No. 5,512, 699 by Connor et al. are suitable materials for the adjunct fabric softener active and are disclosed herein by reference.

Pentaerythritol compounds and derivatives as disclosed in U.S. Pat. No. 6,294,516 are suitable materials for adjunct fabric softener actives and are disclosed herein by reference.

Cyclic polyols and/or reduced saccharides as disclosed in WO 01/07546 A1 are suitable materials for adjunct fabric softener actives and are disclosed herein by reference.

2) Polyquaternary Ammonium Compounds.

The following polyquaternary ammonium compounds are disclosed by reference herein as suitable for use in this invention:

(a) reaction products of substantially unsaturated and/or branched chain higher fatty acids with dialkylenetriamines in, e.g., a molecular ratio of about 2:1, said reaction products containing compounds of the formula:

R¹—C(O)—NH—R²—NH—R³—NH—C(O)—R¹

wherein R¹, R² are defined as above, and each R³ is a C₁₋₆ alkylene group, preferably an ethylene group;

(b) softener having the formula:

[R¹—C(O)—NR—R²—N(R)₂—R³—NR—C(O)—R¹]⁺A⁻

wherein R, R¹, R², R³ and A⁻ are defined as above;

(c) the reaction product of substantially unsaturated and/or branched chain higher fatty acid with hydroxyalkylalkylenediamines in a molecular ratio of about 2: 1, said reaction products containing compounds of the formula:

R¹—C(O)—NH—R²—N(R³OH)—C(O)—R¹

wherein R¹, R² and R³ are defined as above;

European Patent Application EP 0,803,498, A1, Robert O. Keys and Floyd E. Friedli, filed Apr. 25, 1997; British Pat. 808,265, issued Jan. 28, 1956 to Arnold Hoffman & Co., Incorporated; British Pat. 1,161,552, Koebner and Potts, issued Aug. 13, 1969; DE 4,203,489 A1, Henkel, published Aug. 12, 1993; EP 0,221,855, Topfl, Heinz, and Jorg, issued Nov. 3, 1986; EP 0,503,155, Rewo, issued Dec. 20, 1991; EP 0,507,003, Rewo, issued Dec. 20, 1991; EPA 0,803,498, published Oct. 29, 1997; French Pat. 2,523,606, Marie-Helene Fraikin, Alan Dillarstone, and Marc Couterau, filed Mar. 22, 1983; Japanese Pat. 84-273918, Terumi Kawai and Hiroshi Kitamura, 1986; Japanese Pat. 2-011,545, issued to Kao Corp., Jan. 16, 1990; U.S. Pat. No. 3,079,436, Hwa, issued Feb. 26, 1963; U.S. Pat. No. 4,418,054, Green et al., issued Nov. 29, 1983; U.S. Pat. No. 4,721,512, Topfl, Abel, and Binz, issued Jan. 26, 1988; U.S. Pat. No. 4,728,337, Abel, Topfl, and Riehen, issued Mar. 1, 1988; U.S. Pat. No. 4,906,413, Topfl and Binz, issued Mar. 6, 1990; U.S. Pat. No. 5,194,667, Oxenrider et al., issued Mar. 16, 1993; U.S. Pat. No. 5,235,082, Hill and Snow, issued Aug. 10, 1993; U.S. Pat. No. 5,670,472, Keys, issued Sep. 23, 1997; Weirong Miao, Wei Hou, Lie Chen, and Zongshi Li, Studies on Multifunctional Finishing Agents, Riyong Huaxue Gonye, No. 2, pp. 8-10, 1992; Yokagaku, Vol. 41, No. 4 (1992); and Disinfection, Sterilization, and Preservation, 4^{th} Edition, published 1991 by Lea & Febiger, Chapter 13, pp. 226-30. All of these references are incorporated herein, in their entirety, by reference. The products formed by quaternization of reaction products of fatty acid with N,N,N′,N′,-tetraakis(hydroxyethyl)-1,6-diaminohexane are also disclosed as suitable for this invention. Some nonlimiting structural examples produced by this reaction are given below:

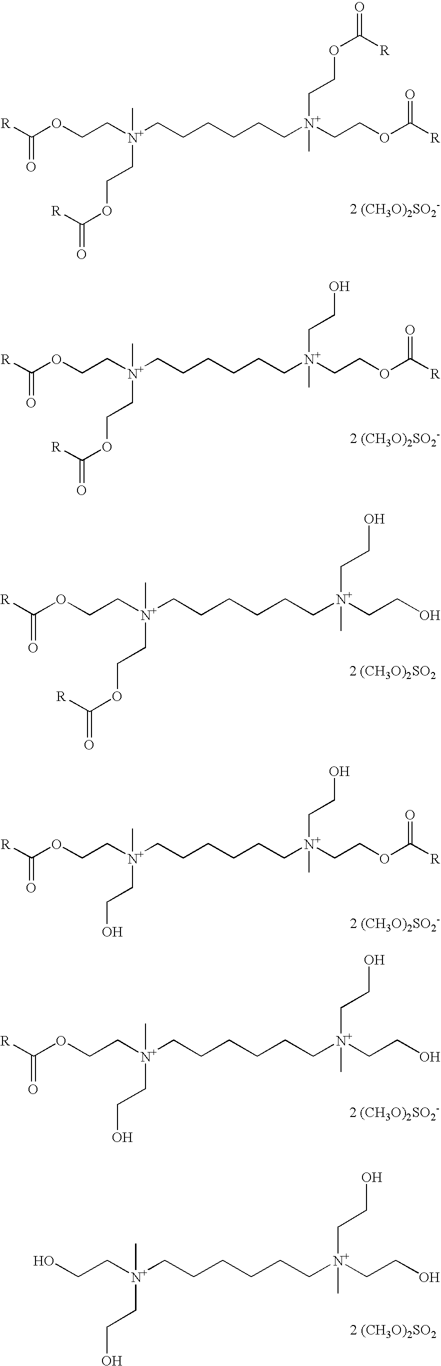

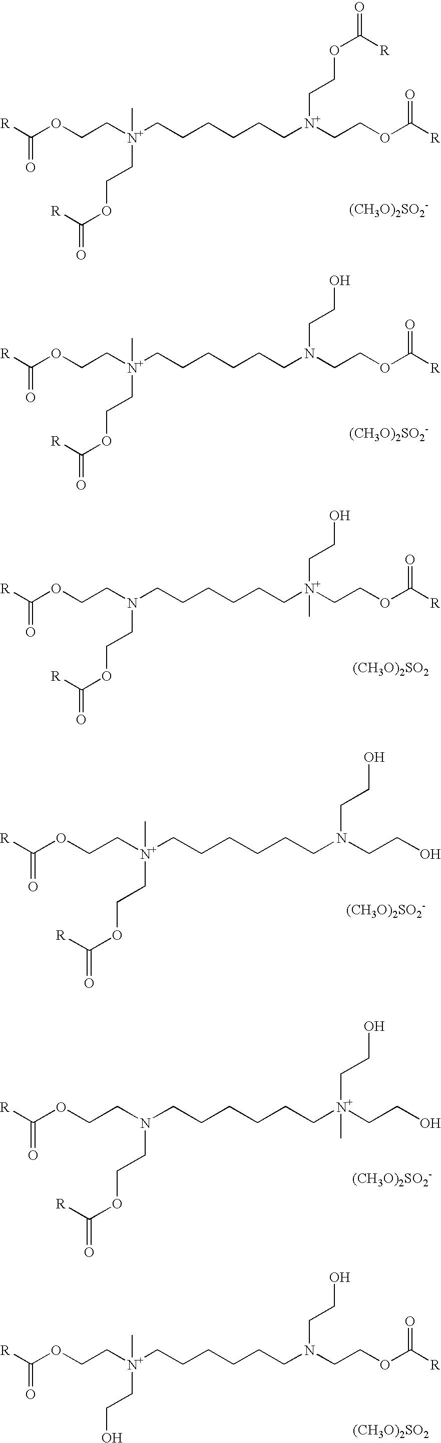

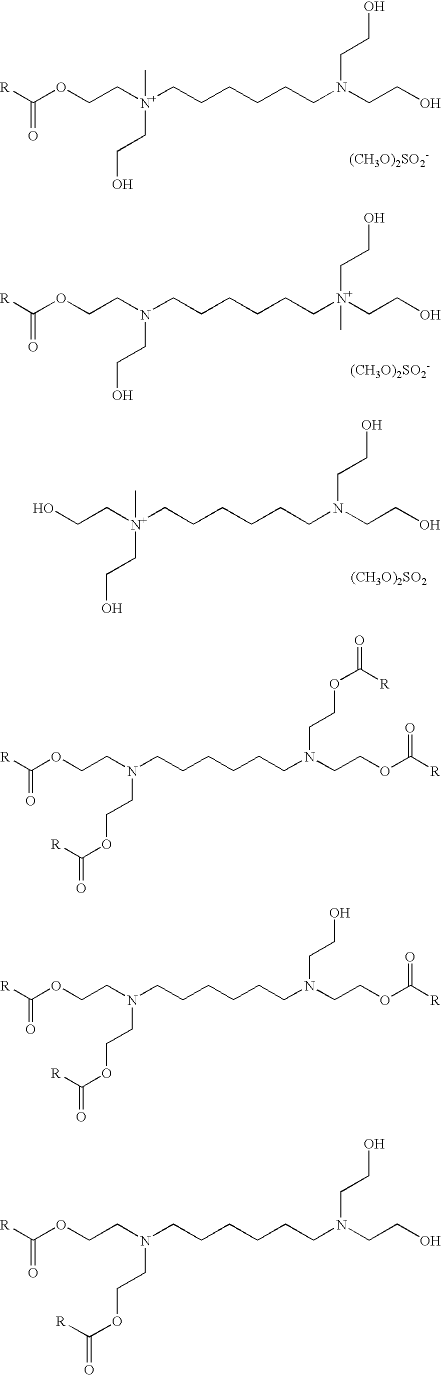

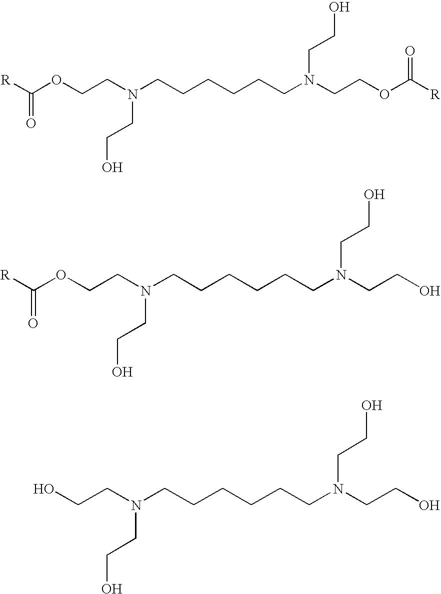

and R is defined as R¹ as described above.

When high unsaturation is present fabric softener actives herein are preferably prepared by a process wherein a chelant, preferably a diethylenetriaminepentaacetate (DTPA) and/or an ethylene diamine-N,N′-disuccinate (EDDS) is added to the process. Another acceptable chelant is tetrakis-(2-hydroxylpropyl) ethylenediamine (TPED). Also, preferably, antioxidants are added to the fatty acid immediately after distillation and/or fractionation and/or during the esterification reactions and/or post-added to the finished softener active. The resulting softener active has reduced discoloration and malodor associated therewith.

The total amount of added chelating agent is preferably within the range of from about 10 ppm to about 5,000 ppm, more preferably within the range of from about 100 ppm to about 2500 ppm by weight of the formed softener active.

The above processes produces a fabric softener active with reduced coloration and malodor.

### Anions Designated by X and A

In the cationic nitrogenous salts herein, the anion which is designated both X⁻ and A⁻ herein, which is any softener compatible anion, provides electrical neutrality. Most often, the anion used to provide electrical neutrality in these salts is from a strong acid, especially a halide, such as chloride, bromide, or iodide. However, other anions can be used, such as methylsulfate, ethylsulfate, acetate, formate, sulfate, carbonate, and the like. Chloride and methylsulfate are preferred herein as anion A. The anion can also, but less preferably, carry a double charge in which case A⁻ represents half a group.

It will be understood that all combinations of softener structures disclosed above are suitable for use in this invention. Other suitable fabric softening active systems and fabric softening actives therefor are described in detail in co-pending U.S. Provisional Application Serial No. 60/388,227 filed Jun. 13, 2002 by G. Frankenbach (Case 8972P).

Liquid Carrier

The compositions of the present invention herein comprise from about 60% to about 90%, preferably from about 65% to about 85% of an aqueous liquid carrier. The preferred aqueous carrier is water which can contain minor ingredients.

Optional Ingredients

The following optional ingredients are useful for improving the performance and/or physical properties of the present invention, agents for pH adjustment, perfume, solvent, salt, monotail amphiphilic compounds, polymers, chelants, color care agents, wrinkle control agents, silicone compound, soil release agent, presevatives, viscosity aids, and the like.

1. Agents for pH Adjustment

Typically, compositions of the present invention have a pH between about 1.5 and 12. Agents for pH adjustment are optional ingredients, but when the composition comprises compounds susceptible to hydrolysis, agents for pH adjustment are highly preferred optional ingredients for adjusting the pH into a range where hydrolytic degredation of the susceptible compounds, particular susceptible fabric softening agents, such as those comprising ester linkages, is significantly reduced. pH ranges for making stable softener compositions containing diester quaternary ammonium fabric softening compounds are disclosed in U.S. Pat. No. 4,767,547, Straathof, issued Aug. 30, 1988, which is incorporated herein by reference.

Fully-formulated fabric softening compositions made by the process of the present invention can optionally contain mineral or organic acids, e.g. HCl, H2SO4, succinic acid, or bases such as ammonium chloride.

2. Perfume

Aesthetic benefits derived from perfumery are highly valued to users of compositions of the present invention. Therefore, perfumes, while optional are highly preferred optional ingredients. The present invention can contain any softener compatible perfume or fragrance ingredient. A non-limiting selection of suitable, but preferred, perfumes are disclosed in U.S. Pat. Nos. 5,500,138 and 5,652,206 said patents being incorporated herein by reference. Perfume can be present at a level of from 0% to 10%. Compositions typically include less than about 3.0%; preferably, less than about 2.0% more preferably less than 1.6%, and typically greater than about 0.5% perfume.

As used herein, perfume includes fragrant substance or mixture of substances including natural (i.e., obtained by extraction of flowers, herbs, leaves, roots, barks, wood, blossoms or plants), artificial (i.e., a mixture of different nature oils or oil constituents) and synthetic (i.e., synthetically produced) odoriferous substances. Such materials are often accompanied by auxiliary materials, such as fixatives, extenders, stabilizers and solvents. These auxiliaries are also included within the meaning of “perfume”, as used herein. Typically, perfumes are complex mixtures of a plurality of organic compounds.

Examples of perfume ingredients useful in the perfumes of the present invention compositions include, but are not limited to, hexyl cinnamic aldehyde; amyl cinnamic aldehyde; amyl salicylate; hexyl salicylate; terpineol; 3,7-dimethyl-cis-2,6-octadien-1-ol; 2,6-dimethyl-2-octanol; 2,6-dimethyl-7-octen-2-ol; 3,7-dimethyl-3-octanol; 3,7-dimethyl-trans-2,6-octadien-1-ol; 3,7-dimethyl-6-octen-1-ol; 3,7-dimethyl-1-octanol; 2-methyl-3-(para-tert-butylphenyl)-propionaldehyde; 4-(4-hydroxy-4-methylpentyl)-3-cyclohexene-1-carboxaldehyde; tricyclodecenyl propionate; tricyclodecenyl acetate; anisaldehyde; 2-methyl-2-(para-iso-propylphenyl)-propionaldehyde; ethyl-3-methyl-3-phenyl glycidate; 4-(para-hydroxyphenyl)-butan-2-one; 1-(2,6,6-trimethyl-2-cyclohexen-1-yl)-2-buten-1-one; para-methoxyacetophenone; para-methoxy-alpha-phenylpropene; methyl-2-n-hexyl-3-oxo-cyclopentane carboxylate; undecalactone gamma.

Additional examples of fragrance materials include, but are not limited to, orange oil; lemon oil; grapefruit oil; bergamot oil; clove oil; dodecalactone gamma; methyl-2-(2-pentyl-3-oxo-cyclopentyl) acetate; beta-naphthol methylether; methyl-beta-naphthylketone; coumarin; decylaldehyde; benzaldehyde; 4-tert-butylcyclohexyl acetate; alpha,alpha-dimethylphenethyl acetate; methylphenylcarbinyl acetate; Schiff's base of 4-(4-hydroxy4-methylpentyl)-3-cyclohexene-1-carboxaldehyde and methyl anthranilate; cyclic ethyleneglycol diester of tridecandioic acid; 3,7-dimethyl-2,6-octadiene-1-nitrile; ionone gamma methyl; ionone alpha; ionone beta; petitgrain; methyl cedrylone; 7-acetyl-1,2,3,4,5,6,7,8-octahydro-1,1,6,7-tetramethyl-naphthalene; ionone methyl; methyl-1,6,10-trimethyl-2,5,9-cyclododecatrien-1-yl ketone; 7-acetyl-1,1,3,4,4,6-hexamethyl tetralin; 4-acetyl-6-tert-butyl-1,1-dimethyl indane; benzophenone; 6-acetyl-1,1,2,3,3,5-hexamethyl indane; 5-acetyl-3-isopropyl-1,1,2,6-tetramethyl indane; 1-dodecanal; 7-hydroxy-3,7-dimethyl octanal; 10-undecen-1-al; iso-hexenyl cyclohexyl carboxaldehyde; formyl tricyclodecan; cyclopentadecanolide; 16-hydroxy-9-hexadecenoic acid lactone; 1,3,4,6,7,8-hexahydro-4,6,6,7,8,8-hexamethylcyclopenta-gamma-2-benzopyrane; ambroxane; dodecahydro-3a,6,6,9a-tetramethylnaphtho-[2,1b]furan; cedrol; 5-(2,2,3-trimethylcyclopent-3-enyl)-3-methylpentan-2-ol; 2-ethyl4-(2,2,3-trimethyl-3-cyclopenten-1-yl)-2-buten-1-ol; caryophyllene alcohol; cedryl acetate; para-tert-butylcyclohexyl acetate; patchouli; olibanum resinoid; labdanum; vetivert; copaiba balsam; fir balsam; and condensation products of: hydroxycitronellal and methyl anthranilate; hydroxycitronellal and indol; phenyl acetaldehyde and indol; 4-(4-hydroxy-4-methyl pentyl)-3-cyclohexene-1-carboxaldehyde and methyl anthranilate.

More examples of perfume components are geraniol; geranyl acetate; linalool; linalyl acetate; tetrahydrolinalool; citronellol; citronellyl acetate; dihydromyrcenol; dihydromyrcenyl acetate; tetrahydromyrcenol; terpinyl acetate; nopol; nopyl acetate; 2-phenylethanol; 2-phenylethyl acetate; benzyl alcohol; benzyl acetate; benzyl salicylate; benzyl benzoate; styrallyl acetate; dimethylbenzylcarbinol; trichloromethylphenylcarbinyl methylphenylcarbinyl acetate; isononyl acetate; vetiveryl acetate; vetiverol; 2-methyl-3-(p-tert-butylphenyl)-propanal; 2-methyl-3-(p-isopropylphenyl)-propanal; 3-(p-tert-butylphenyl)-propanal; 4-(4-methyl-3-pentenyl)-3-cyclohexenecarbaldehyde; 4-acetoxy-3-pentyltetrahydropyran; methyl dihydrojasmonate; 2-n-heptylcyclopentanone; 3-methyl-2-pentyl-cyclopentanone; n-decanal; n-dodecanal; 9-decenol-1; phenoxyethyl isobutyrate; phenylacetaldehyde dimethylacetal; phenylacetaldehyde diethylacetal; geranonitrile; citronellonitrile; cedryl acetal; 3-isocamphylcyclohexanol; cedryl methylether; isolongifolanone; aubepine nitrile; aubepine; heliotropine; eugenol; vanillin; diphenyl oxide; hydroxycitronellal ionones; methyl ionones; isomethyl ionomes; irones; cis-3-hexenol and esters thereof; indane musk fragrances; tetralin musk fragrances; isochroman musk fragrances; macrocyclic ketones; macrolactone musk fragrances; ethylene brassylate.

Suitable solvents, diluents or carriers for perfumes ingredients mentioned above are for examples, ethanol, isopropanol, diethylene glycol, monoethyl ether, dipropylene glycol, diethyl phthalate, triethyl citrate, etc. The amount of such solvents, diluents or carriers incorporated in the perfumes is preferably kept to the minimum needed to provide a homogeneous perfume solution.

Perfume ingredients may also be suitably added as releasable fragrances, for example, as pro-perfumes or pro-fragrances as described in U.S. Pat. No. 5,652,205 Hartman et al., issued Jul. 29, 1997 incorporated herein by reference.

Perfume is a highly desirable optional due to the ability of perfume to strongly improve consumer acceptance of compositons disclosed herein.

3. Solvents & Solvatropes

Solvents and solvatropes both those that are water-miscible and water immiscible, can be useful for imparting stability improvements to compositions disclosed herein, together with stability improvements imparted due to mixing of appropriate PFSA and FSCA. Additionally, solvents and solvatropes can be helpful in improving the dispersibility of concentrated compositions. Some preferred, but non-limiting solvents and solvatropes include materials comprising about 2 to about 12 carbons and 1 to about 6 oxygens such as ethanol, isopropanol, hexylene glycol, 1,2-hexanediol, propylene glycol, 2,22,4-trimethyl-1,3-pentanediol, 2-ehtylhexyl-1,3-diol. Additional suitable solvent and solvatrope materials include compounds with a Clog P from about −2 to about 2.6 as disclosed in U.S. application Ser. Nos. 09/308,128 filed May 10, 1999, and 09/554,969 filed May 23, 2000 by Frankenbach et al.

4. Salts & Hydrotropes

Salts and hydrotropes, can be useful for imparting stability improvements to compositions disclosed herein, together with stability improvements imparted due to mixing of appropriate PFSA and FSCA. Additionally, salts and hydrotropes can be helpful in improving the dispersibility of concentrated compositions. Some preferred, but non-limiting salts include halids of the group IA and IIA metals on the the periodic chart such as NaCl, CaCl₂, and MgCl₂. Organic salts are also useful for the compositions further improving the stability of compositions disclosed herein. Some nonlimiting examples of hydrotropes are sodium cumeme sulfonate, sodium xylene sulfonate, calcium cumene sulfonate, calcium xylene sulfonate. A more comprehensive list of useful salts and hydrotropes is described in U.S. application Ser. Nos. 09/308,128 filed May 10, 1999, and 09/554,969 filed May 23, 2000 by Frankenbach et al.

5. Mono-Tail Amphiphilic Compounds:

It is often desireable to add an optional mono-tail amphiphilic compound to improve a variety of performance attributes including but not limited to improved softening performance, improved wrinkle control performance, and improved dispersibility. In general, these are materials having a hydrocarbyl chain with equal to or greater than about six carbons. Such materials can be nonionic cationic or zwitterionic, or anionic. When monotail materials are used to provided benefit improvements, the materials are included at levels of from about 0.5% to about 10%, and preferably from about 1% to about 5%. Materials which provide benefits as dispersibility aids are disclosed in U.S. application Ser. Nos. 09/622,968 filed Mar. 2, 1999 by Duval et al. and in U.S. Pat. No. 5,545,340 issued Aug. 13, 1996 to Wahl et al.

Other optional but highly desirable cationic compounds which can be used in combination with the above softener actives are compounds containing one long chain acyclic C₈-C₂₂ hydrocarbon group, selected from the group consisting of:

[R¹—N(R⁵)₃]+A⁻

R¹ is hydrocarbon group having about 6 to about 22 carbons that is preferably, but not necessarily linear. R⁵ is a hydrogen or a hydrocarbon having less than about 10 carbons. Each R⁵ can be the same or different.

6. Cationic Polymers

Cationic Polymers are useful for boosting performance benefits such as softening, wrinkle control, and color care. Not to be bound by theory, but it is believed that cationic polymers function via a variety of mechanisms. Cationic polymers can scavenge residual anionic surfactants carried over into the rinse from laundry detergent used in the wash cycle. In this way, the cationic polymer protects the fabric softener active from complexing with the anionic surfactant which would reduce the efficacy of the active. Cationic polymers can also smooth out fibers by pasting down fibrils and the resulting reduced potential for physical entanglement and friction between fibers contributes to improving wrinkle control performance.

Composition herein can contain from about 0.001% to about 10%; preferably from about 0.01% to about 5%′ more preferably from about 0.1% to about 2% of cationic polymer, typically having a molecular weight of from about 500 to about 10,000,000; preferably from about 1,000 to bout 250,000 and a charge density of at least about 0.01 meq/g preferably from about 0.01 meq/g to about 8 meq/g.

The cationic polymers of the present invention can be amin salts or quaternary ammonium salts. They include cationic derivatives of natural polymers such as some polysaccharide gums, starch, and certain cationic synthetic polymers and co-polymers of cationic vinyl pyridine or vinyl pyridinium halides. Preferably the polymers are water soluble for instanc to the extent of at least 0.5% by weight at 20 C.

Suitable dersirable cationic polymers are disclosed in CTFA International Cosmetic Ingredient Dictionary, 4^{th} Ed., J. M. Nikitakis, et al., Editors, published by the Cosmetic, Toiletry, and Fragran Association, 1991, incorporated herein by reference. Also, suitable cationic polymers and polyethyleneimines are disclosed in the following references included herein by reference, U.S. Pat. No. 5,977,055, Trinh et al. issued Nov. 02, 1999, U.S. Pat. No. 2,182,306, Ulrich et al. issued Dec. 5, 1939, U.S. Pat. No. 3,033,746, Mayle et al., issued May 8, 1962; U.S. Pat. No. 2,208,095, Esselmann et al., issued Jul. 16, 1940; U.S. Pat. No. 2,806,839, Crowther, issued Sep. 17, 1957; U.S. Pat. No. 2,553,696, Wilson, issued May 21, 1951.

7. Color Care Agents

There are a variety of materials that can provide color care improvements in the context of the present compositions. These include chlorine protection agents, dye transfer inhibitors, dye fixatives, and chelants.

a) Chlorine Protection Agents

Chlorine protection agents are materials that react with or nuetralize the bleaching efficacy of chlorine or with chlorine generating materials like hypochlorite to eliminate or the bleaching activity of chlorine generating materials. An effective amount of chlorine scavenger can be selected from the following non-limiting groups: 1) amines and their salts, 2) ammonium salts, 3) amino acids and their salts, 3) polyamino acids and their salts, 4) polyehtyleneimines and their salts, 5) polyamines and their salts, 6) polyamineamides and their salts, 7) polyacrylamides and their salts, 8) and combinations thereof. For use in rinse-added compositions of the present invention it is suitable to incorporate enough chlorine scavenger to scavenge about 1 ppm of chlorine, preferably 2 ppm, more preferably 3 pm, and most preferably 10 ppm of chlorine in the rinse. The structure, use, and incorporation of chlorine protection agents useful in fabric care compositions are disclosed in more detail in U.S. Pat. Nos. 5,977,055, 6,046,155 both by T. Trinh et al, and U.S. Pat. No. 6,107,270 by J. W. Smith et al. and this information is included herein by reference.

b) Dye Transfer Inhibitors (DTI)

Dye transfer inhibitors are materials that prevent fugitive dyes in the rinse liquor from redepositing on fabrics. Fugitive dyes are dye molecules or aggregates that have left fabric they were associated with prior to the wash process and then entered the wash and/or rinse baths. DTI's appear to function by solubilzing in water, binding with fugitive dyes and thus preventing the fugitive dyes from redepositing on fabric. Redeposition of fugitive dyes corrupts the orginal color of a fabric leading to loss of color fidelity over time. DTI's are typically, but not necessarily polymeric materials. Preferably, the DTI is a water soluble polymer comprising oxygen or nitrogen atoms selected from the group consisting of 1) polymers which are preferably not enzymes, with one or more monomeric units containing at least one ═N—C(═0) group; 2) polymers with one or more monomeric units containing at least one N-oxide group; 3) polymers containing both ═N—C(═O) and N-oxide groups; and 4) mixtures thereof; wherein the nitrogen of the ═N—C(═O) can be bond to one or two other atoms (i.e. can have two single bonds or one double bond). Polyvinyl pyrrolidone is a typical, but nonlimiting examples of such structures. ne effective amount of DTI in the present composition, is an amount that releases at least about 0.1 ppm in the rinse liquor, preferably about 0.1 ppm to about 100 ppm, more preferably about 0.2 ppm to about 20 ppm is released in the rinse liquor. Suitable structures, use and incorporation of DTI's in fabric care compositions are disclosed in further detail in the following patents WO 94/11482 published 26 May 1994 and U.S. Pat. No. 5,977,055 by T. Trinh et al. granted 2 Nov. 1999.

c) Dye Fixatives

Dye fixatives are similar to dye transfer inhibitors, but tend to be more water insoluble. They act primarily by inhibiting removal of the dye rather than intercepting it in the water phase and keeping it suspended like the DTI'S. Dye fixatives that are suitable for the present invention are disclosed in U.S. Pat. No. 5,632,781, Shinichie et al. granted 27 May 1997, U.S. Pat. No. 4,583,989 Toshino et al. issued Apr. 22, 1986; U.S. Pat. No. 3,957,574 Edward granted May 18, 1975; U.S. Pat. No. 3,957,427 Chambers issued May 18, 1976; U.S. Pat. No. 3,940,247 Derwin et al. granted Feb. 24, 1976, all of the said patents being incorporated by reference.

The dye fixatives are used in at least an effective amount, typically from about 0.01% to about 10%, preferably from about 0.03% to about 7%, more preferably from about 0.1% to about 3%.

d) Chelants

Chelants are also suitable materials for imparting improved color protection in the present invention. Chelants are typically effective by binding metals in solution or precipitating metals out of solutions.

Polyamine compounds particularly those with the structure below are preferred materials to impart color care through chelating action:

(R¹)₂N(CX₂)ₙN(R²)₂

wherein each X is preferably hydrogen but other suitable structures for X include linear or branched alkyl groups that are substituted or unsubstituted comprising 1 to about 10 carbons, but preferably 1 to 2 carbons; aryl groups with at least about 5 carbons and preferably from 5 to about 22 carbons, and mixtures thereof; n is an interger from 0 to about 6 preferably from 2 to about 3; each R¹ and R² is independently selected from the group consisting of hydrogen, alkyl, aryl, akylaryl, hydroxyalkyl, polyhydroxyalkyl, C₁₋₁₀, preferably C₂₋₃, alkyl groups substituted with preferably 1 or suitably more carboxylic acid or phosphonic acid groups or salts; and when substituted with more than one acid or salt, the substitution number is preferably 2 or 3; polyalkyether having the structure —((CH2)yO)z—R3, where each R3 is preferably hydrogen or suitably a linear or branched, substituted or unsubstituted alkyl group having from about 1 to about 10 carbons, preferably from about 1 to about 4 carbon atoms and where y is an interger from about 2 to about 10, preferably from about 2 to about 3 and z is an interger from about 1 to abou 30, preferably from about 2 to about 5; R3 can also suitably include —C(O)R4 where each R⁴ is selected from the group consisting of alkyl, aryl, alkylaryl, hydroxyalkyl polyhydroxyalkyl polyalkylether and alkyl groups substituted with most preferably one, but suitably more (preferably 2 or 3) carboxylic acid and phosphonic acid groups or salts, —CX₂CX₂N(R⁵) with no more than one of R¹ or R² being —CX₂CX₂N(R⁵) and is selected from the group consisting of is selected from the group consisting of alkyl, aryl, alkylaryl, hydroxyalkyl polyhydroxyalkyl polyalkylether and alkyl groups substituted with most preferably one, but suitably more (preferably 2 or 3) carboxylic acid and phosphonic acid groups or salts as defined in R¹ or R², and one R¹ and one R² can combine to form a cyclic compound.

A variety of other polyanionic groups are suitable as chelating agents including, but not limited to citric acid, citrate salts, isoporpyl citrate, 1-hydroxyethylidene- 1,1-diphosphonic acid available as Dequest RTM 20110 from Monsanto, 4,5-dihydroxy-m-benzenesulfonic acid/sodium salt available from Kodak as Tiron RTM, diethylenetriaminepentaacidic acid available from Aldrich, ethylenediaminetetraacetic acid (EDTA), ethylenediamine-N,N′-disuccinic acid (EDDS preferably the S,S isomer) 8-hydroxyquinoline, sodium dithiocarbamate, sodium tetraphenyl boron, ammonium nitrosophenyl hydroxylamine, and mixtures thereof. Chelants, when used, are included at levels of from about 0.01% to about 10% preferably from about 0.1% to about 8%, and most preferably from about 0.5% to about 5%. The structures, use, and incorporation of chelants in fabric care compositions for imparting color care are disclosed in more detail in the following U.S. Pat. No. 5,977,055 by T. Trinh et al. and U.S. Pat. No. 5,686,376 issued Nov. 11, 1997 to J. Rusche et al.

8. Enzymes

The compositions and processes herein can optionally comprise one or more enzymes such as lipases, proteases, cellulase, amylases and peroxidases. A preferred enzyme for use herein is a cellulase enzyme. Indeed, this type of enzyme will further provide a color care benefit to the treated fabric. Cellulases usable herein include both bacterial and fungal types, preferably having a pH optimum between 5 and 9.5. U.S. Pat. No. 4,435,307 discloses suitable fungal cellulases from Humicola insolens or Humicola strain DSM1800 or a cellulase 212-producing fungus belonging to the genus Aeromonas, and cellulase extracted from the hepatopancreas of a marine mollusk, Dolabella Auricula Solander. Suitable cellulases are also disclosed in GB-A-2.075.028; GB-A-2.095.275 and DE-OS-2.247.832. CAREZYME® and CELLUZYME® (Novo) are especially useful. Other suitable cellulases are also disclosed in WO 91/17243 to Novo, WO 96/34092, WO 96/34945 and EP-A-0,739,982. In practical terms for current commercial preparations, typical amounts are up to 5 mg by weight, more typically 0.01 mg to 3 mg, of active enzyme per gram of the detergent composition. Stated otherwise, the compositions herein will typically comprise from 0.001% to 5%, preferably 0.01%-1% by weight of a commercial enzyme preparation. In the particular cases where activity of the enzyme preparation can be defined otherwise such as with cellulases, corresponding activity units are preferred (e.g. CEVU or cellulase Equivalent Viscosity Units). For instance, the compositions of the present invention can contain cellulase enzymes at a level equivalent to an activity from 0.5 to 1000 CEVU/gram of composition. Cellulase enzyme preparations used for the purpose of formulating the compositions of this invention typically have an activity comprised between 1,000 and 10,000 CEVU/gram in liquid form, around 1,000 CEVU/gram in solid form.

9. Silicone Containing Agents

Silicone containing agents are useful for a variety of purposes. Silicone containing agents can be used as suds supressors during making and in use of the composition. Silicone containing materials are also useful for imparting wrinkle control benefits.

a) Silicone Suds Suppressors

Silicone compositions based on PDMS that provide suds suppression are acceptable optional ingredients for the present invention.

b) Silicones for Wrinkle Control

Although a variety of silicones are effective as wrinkle control agents, highly preferred silicones for wrinkle control are silicones or silicone emulsions wherein the silicone species comprises amines, particularly when. the amines are cationically charged. Still preferred, but less so, are nuetral silicone compounds delivered as silicone emulsions comprising cationically charged emulsifiers.

Some nonlimiting examples of the highly preferred silicone compounds comprising amines are 929 Cationic Emulsion, 939 Cationic Emulsion, 949 Cationic Emulsion, 2-8194 Microemulsion available from Dow Coming as well as materials described in U.S. application Ser. No. 09/935,927 filed Aug. 23, 2001 by A. Masschelein et al. and in WO 99/32539.

When such silicone compounds are used to provide wrinkle control these are incorporated in the present composition at levels of from about 0.001% to about 10%, more preferably from about 0.1% to about 5%, and most preferably below about 2%.

10. Wrinkle Control Agents

PFSA and FSCA impart large wrinkle benefits vs. fabrics which are not treated with compositions comprising PFSA's or FSCA's. However, it is possible to boost the wrinkle control properties of compositions disclosed herein. Some compounds useful for wrinkle control are disclose below.

a) Polycationic Polymers

Polycationic polymers as disclosed above in the section entitled ‘polymers’ provide improvements in wrinkle control when used at levels disclosed above.

b) Silicone Containing Agents

Silicone containing agents disclosed above are useful in the present composition for improving wrinkle control in when used in the levels described above under section 9b.

c) Enzymes

Enzymatic compound such as those disclosed herein above and particularly cellulase and other enzymes capable of modifiying cellulosic surfaces can provide wrinkle control benefits. Not to be bound by theory, but enzymes effect wrinkle control by removing pills and irregularities from fiber surfaces thus reducing tangling and friction between fibers and thus allows wrinkles to be removed from fabrics.

11. Soil Release Agent

Particular to the embodiments of the rinse-added fabric softeners according to the present invention, certain soil release agents provide not only the below described soil release properties but are added for their suitability in maintaining proper viscosity, especially in the dispersed phase, non-isotropic compositions.

Any polymeric soil release agent known to those skilled in the art can optionally be employed in the compositions and processes of this invention. Polymeric soil release agents are characterized by having both hydrophilic segments, to hydrophilize the surface of hydrophobic fibers, such as polyester and nylon, and hydrophobic segments, to deposit upon hydrophobic fibers and remain adhered thereto through completion of the rinsing cycle and, thus, serve as an anchor for the hydrophilic segments. This can enable stains occurring subsequent to treatment with the soil release agent to be more easily cleaned in later washing procedures.

If utilized, soil release agents will generally comprise from about 0.01% to about 10.0%, by weight, of the detergent compositions herein, typically from about 0.1% to about 5%, prefer-ably from about 0.2% to about 3.0%.

The following, all included herein by reference, describe soil release polymers suitable for use in the present invention. U.S. Pat. No. 3,959,230 Hays, issued May 25, 1976; U.S. Pat. No. 3,893,929 Basadur, issued Jul. 8, 1975; U.S. Pat. No. 4,000,093, Nicol, et al., issued Dec. 28, 1976; U.S. Pat. No. 4,702,857 Gosselink, issued Oct. 27, 1987; U.S. Pat. No. 4,968,451, Scheibel et al., issued Nov. 6; U.S. Pat. No. 4,702,857, Gosselink, issued Oct. 27, 1987; U.S. Pat. No. 4,711,730, Gosselink et al., issued Dec. 8, 1987; U.S. Pat. No. 4,721,580, Gosselink, issued Jan. 26, 1988; U.S. Pat. No. 4,877,896, Maldonado et al., issued Oct. 31, 1989; U.S. Pat. No. 4,956,447, Gosselink et al., issued Sep. 11, 1990; U.S. Pat. No. 5,415,807 Gosselink et al., issued May 16, 1995; European Patent Application 0 219 048, published Apr. 22, 1987 by Kud, et al..

Further suitable soil release agents are described in U.S. Pat. No. 4,201,824, Violland et al.;, U.S. Pat. No. 4,240,918 Lagasse et al.; U.S. 4,525,524 Tung et al.; U.S. Pat. No. 4,579,681, Ruppert et al.; U.S. Pat. No. 4,240,918; U.S. Pat. No. 4,787,989; U.S. Pat. No. 4,525,524; EP 279,134 A, 1988, to Rhone-Poulenc Chemie; EP 457,205 A to BASF (1991); and DE 2,335,044 to Unilever N. V., 1974 all incorporated herein by reference.

Commercially available soil release agents include the METOLOSE SM100, METOLOSE SM200 manufactured by Shin-etsu Kagaku Kogyo K. K., SOKALAN type of material, e.g., SOKALAN HP-22, available from BASF (Germany), ZELCON 5126 (from Dupont) and MILEASE T (from ICI).

A preferred soil release agent is described in U.S. Pat. No. 4,702,857 Gosselink, issued Oct. 27, 1987.

12. Presevatives

Quaternary materials such as the PFSA's and FSCA's diclosed in the present invention are effective in and of themselves as preservatives in a variety of circumstances. When additional preservative functionality is desired, materials disclosed below are nonlimiting examples of effective antimicrobial actives which are useful in the present invention:

Pyrithiones, especially the zinc complex (ZPT); Octopirox; Parabens, including Methylparaben, Propylparaben, Butylparaben, Ethylparaben, Isopropylparaben, Isobutylparaben, Benzylparaben, Sodium Methylparaben, and Sodium Propylparaben; DMDM Hydantoin (Glydant); Methylchloroisothiazolinone/methylisothiazolinone (Kathon® CG); 1,2benzisothiazolin-3-one (Proxel® GXL), Sodium Sulfite; Sodium Bisulfite; Imidazolidinyl Urea; Diazolidinyl Urea (Germail 2); Sorbic Acid/Potassium Sorbate; Dehydroacetic Acid/Sodium Dehydroacetate; Benzyl Alcohol; Sodium Borate; 2-Bromo-2-nitropropane-1,3-diol (Bronopol); Formalin; lodopropynyl Butylcarbamate; Boric Acid; Chloroacetamide; Methenamine; Methyldibromo Glutaronitrile; Glutaraldehyde; Hexamidine Isethionate; 5-bromo-5-nitro-1,3-dioxane; Phenethyl Alcohol; o-Phenylphenol/sodium o-phenylphenol; Sodium Hydroxymethylglycinate; Polymethoxy Bicyclic Oxazolidine; Dimethoxane; Thimersol; Dichlorobenzyl alcohol; Captan; Chlorphenenesin; Dichlorophene; Chlorbutanol; Phenoxyethanol; Phenoxyisopropanol; Halogenated Diphenyl Ethers; 2,4,4′-trichloro-2′-hydroxy-diphenyl ether (Triclosan); 2,2′-dihydroxy-5,5′-dibromo-diphenyl ether; Phenolic Compounds—(including phenol and its homologs, mono- and poly-alkyl and aromatic halophenols, resorcinol and its derivatives, bisphenolic compounds and halogenated salicylanilides); Phenol and its Homologs including Phenol, 2 Methyl Phenol, 3 Methyl Phenol, 4 Methyl Phenol, 4 Ethyl Phenol, 2,4-Dimethyl Phenol, 2,5-Dimethyl Phenol, 3,4-Dimethyl Phenol, 2,6-Dimethyl Phenol, 4-n-Propyl Phenol, 4-n-Butyl Phenol, 4-n-Amyl Phenol, 4-tert-Amyl Phenol, 4-n-Hexyl Phenol, and 4-n-Heptyl Phenol; Mono- and Poly-Alkyl and Aromatic Halophenols including p-Chlorophenol, Methyl p-Chlorophenol, Ethyl p-Chlorophenol, n-Propyl p-Chlorophenol, n-Butyl p-Chlorophenol, n-Amyl p-Chlorophenol, sec-Amyl p-Chlorophenol, n-Hexyl p-Chlorophenol, Cyclohexyl p-Chlorophenol, n-Heptyl p-Chlorophenol, n-Octyl p-Chlorophenol, o-Chlorophenol, Methyl o-Chlorophenol, Ethyl o-Chlorophenol, n-Propyl o-Chlorophenol, n-Butyl o-Chlorophenol, n-Amyl o-Chlorophenol, tert-Amyl o-Chlorophenol, n-Hexyl o-Chlorophenol, n-Heptyl o-Chlorophenol, o-Benzyl p-Chlorophenol, o-benzyl-m-methyl p-Chlorophenol, o-Benzyl-m, m-dimethyl p-Chlorophenol, o-Phenylethyl p-Chlorophenol, o-Phenylethyl-m-methyl p-Chlorophenol, 3-Methyl p-Chlorophenol, 3,5-Dimethyl p-Chlorophenol, 6-Ethyl-3-methyl p-Chlorophenol, 6-n-Propyl-3-methyl p-Chlorophenol, 6-iso-Propyl-3-methyl p-Chlorophenol, 2-Ethyl-3,5-dimethyl p-Chlorophenol, 6-sec-Butyl-3-methyl p-Chlorophenol, 2-iso-Propyl-3,5-dimethyl p-Chlorophenol, 6-Diethylmethyl-3-methyl p-Chlorophenol, 6-iso-Propyl-2-ethyl-3-methyl p-Chlorophenol, 2-sec-Amyl-3,5-dimethyl p-Chlorophenol, 2-Diethylmethyl-3,5-dimethyl p-Chlorophenol, 6-sec-Octyl-3-methyl p-Chlorophenol, p-Chloro-m-cresol, p-Bromophenol, Methyl p-Bromophenol, Ethyl p-Bromophenol, n-Propyl p-Bromophenol, n-Butyl p-Bromophenol, n-Amyl p-Bromophenol, sec-Amyl p-Bromophenol, n-Hexyl p-Bromophenol, cyclohexyl p-Bromophenol, o-Bromophenol, tert-Amyl o-Bromophenol, n-Hexyl o-Bromophenol, n-Propyl-m,m-Dimethyl o-Bromophenol, 2-Phenyl Phenol, 4-Chloro-2-methyl phenol, 4-Chloro-3-methyl phenol, 4-Chloro-3,5-dimethyl phenol, 2,4-dichloro-3,5-dimethylphenol, 3,4,5,6-terabromo-2-methylphenol, 5-methyl-2-pentylphenol, 4-isopropyl-3-methylphenol, para-chloro-meta-xylenol (PCMX), 5-Chloro-2-hydroxydiphenylmethane; Resorcinol and its Derivatives including Resorcinol, Methyl Resorcinol, Ethyl Resorcinol, n-Propyl Resorcinol, n-Butyl Resorcinol, n-Amyl Resorcinol, n-Hexyl Resorcinol, n-Heptyl Resorcinol, n-Octyl Resorcinol, n-Nonyl Resorcinol, Phenyl Resorcinol, Benzyl Resorcinol, Phenylethyl Resorcinol, Phenylpropyl Resorcinol, p-Chlorobenzyl Resorcinol, 5-Chloro 2,4-Dihydroxydiphenyl Methane, 4′-Chloro 2,4-Dihydroxydiphenyl Methane, 5-Bromo 2,4-Dihydroxydiphenyl Methane, and 4′-Bromo 2,4-Dihydroxydiphenyl Methane; Bisphenolic Compounds including 2,2′-, methylene bis (4-chlorophenol), 2,2′-methylene bis (3,4,6-trichlorophenol), 2,2′-methylene bis (4-chloro-6-bromophenol), bis (2-hydroxy-3,5-dichlorophenyl) sulphide, and bis (2-hydroxy-5-chlorobenzyl)sulphide; Benzoic Esters including p-Hydroxybenzoic Acid, Methyl p-Hydroxybenzoic Acid, Ethyl p-Hydroxybenzoic Acid, Propyl p-Hydroxybenzoic Acid, and Butyl p-Hydroxybenzoic Acid.

Another class of antibacterial agents, which are useful in the present invention, are the so-called “natural” antibacterial actives, referred to as natural essential oils. These actives derive their names from their natural occurrence in plants. Typical natural essential oil antibacterial actives include oils of anise, lemon, orange, rosemary, wintergreen, thyme, lavender, cloves, hops, tea tree, citronella, wheat, barley, lemongrass, cedar leaf, cedarwood, cinnamon, fleagrass, geranium, sandalwood, violet, cranberry, eucalyptus, vervain, peppermint, gum benzoin, Hydastis carradensis, Berberidaceae. daceae, Ratanhiae and Curcuma longa. Also included in this class of natural essential oils are the key chemical components of the plant oils which have been found to provide the antimicrobial benefit. These chemicals include, but are not limited to anethol, catechole, camphene, thymol, eugenol, eucalyptol, ferulic acid, famesol, hinokitiol, tropolone, limonene, menthol, methyl salicylate, salicylic acid, thymol, terpineol, verbenone, berberine, ratanhiae extract, caryophellene oxide, citric acid, citronellic acid, curcumin, nerolidol, geraniol and benzoic acid.

Additional active agents are antibacterial metal salts. This class generally includes salts of metals in groups 3b-7b, 8 and 3a-5a. Specifically are the salts of aluminum, zirconium, zinc, silver, gold, copper, lanthanum, tin, mercury, bismuth, selenium, strontium, scandium, yttrium, cerium, praseodymiun, neodymium, promethum, samarium, europium, gadolinium, terbium, dysprosium, holmium, erbium, thulium, ytterbium, lutetium and mixtures thereof.

Preferred antimicrobial agents for use herein are the broad spectrum actives selected from the group consisting of Triclosan, phenoxyisopropanol, phenoxyethanol, PCMX, natural essential oils and their key ingredients, and mixtures thereof. The most preferred antimicrobial active for use in the present invention is Triclosan.

A wide range of quaternary compounds can also be used as antimicrobial actives, in conjunction with the preferred surfactants, for compositions of the present invention. Non-limiting examples of useful quaternary compounds include: (1) benzalkonium chlorides and/or substituted benzalkonium chlorides such as commercially available Barquat® (available from Lonza), Maquat® (available from Mason), Variquat® (available from Witco/Sherex), and Hyamine® (available from Lonza); (2) di(C₆-C₁₄)alkyl di-short chain (C₁₋₄ alkyl and/or hydroxyalkyl) quaternary such as Bardac® products of Lonza. These quaternary compounds contain two relatively short chains, e.g., C₁₋₄ alkyl and/or hydroxy alkyl groups and two C₆₋₁₂, preferably C₆₋₁₀, and more preferably C₈, alkyl groups,(3) N-(3-chloroallyl) hexaminium chlorides such as Dowicide® and Dowicil® available from Dow; (4) benzethonium chloride such as Hyamine® 1622 from Rohm & Haas; (5) methylbenzethonium chloride represented by Hyamine® 10× supplied by Rohm & Haas, (6) cetylpyridinium chloride such as Cepacol chloride available from of Merrell Labs. Examples of the preferred dialkyl quaternary compounds are didecyl dimethyl ammonium chlorid (Bardac® 2250) di(C₈-C₁₂)dialkyl dimethyl ammonium chloride, such as didecyldimethylamrnmonium chloride (Bardac® 22), and dioctyldimethylammonium chloride (Bardac® 2050). Typical concentrations for biocidal effectiveness of these quaternary compounds range from about 0.001% to about 0.8%, preferably from about 0.005% to about 0.3%, more preferably from about 0.01% to 0.2%, by weight of the usage composition. The corresponding concentrations for the concentrated compositions are from about 0.003% to about 2%, preferably from about 0.006% to about 1.2%, and more preferably from about 0.1% to about 0.8% by weight of the concentrated compositions.

Sanitization of fabrics can be achieved by the compositions of the present invention containing, antimicrobial materials, e.g., antibacterial halogenated compounds, quaternary compounds, and phenolic compounds.

Some of the more robust antimicrobial halogenated compounds which can function as disinfectants/sanitizers as well as finish product preservatives (vide infra), and are useful in the compositions of the present invention include 1,1′-hexamethylene bis(5-(p-chlorophenyl)biguanide), commonly known as chlorhexidine, and its salts, e.g., with hydrochloric, acetic and gluconic acids. The digluconate salt is highly water-soluble, about 70% in water, and the diacetate salt has a solubility of about 1.8% in water. When chlorhexidine is used as a sanitizer in the present invention it is typically present at a level of from about 0.001% to about 0.4%, preferably from about 0.002% to about 0.3%, and more preferably from about 0.05% to about 0.2%, by weight of the usage composition. In some cases, a level of from about 1% to about 2% may be needed for virucidal activity.

Other useful biguanide compounds include Cosmoci® CQ®, Vantocil® IB, including poly (hexamethylene biguanide) hydrochloride. Other useful cationic antimicrobial agents include the bis-biguanide alkanes. Usable water soluble salts of the above are chlorides, bromides, sulfates, alkyl sulfonates such as methyl sulfonate and ethyl sulfonate, phenylsulfonates such as p-methylphenyl sulfonates, nitrates, acetates, gluconates, and the like.

Examples of suitable bis biguanide compounds are chlorhexidine; 1,6-bis-(2-ethylhexylbiguanidohexane)dihydrochloride; 1,6-di-(N₁,N₁′-phenyldiguanido-N₅,N₅′)-hexane tetrahydrochloride; 1,6-di-(N₁,N₁′-phenyl-N₁,N₁′-methyldiguanido-N₅,N₅′)-hexane dihydrochloride; 1,6-di(N₁,N₁′-o-chlorophenyldiguanido-N₅,N₅′)-hexane dihydrochloride; 1,6-di(N₁,N₁′-2,6-dichlorophenyldiguanido-N₅,N₅′)hexane dihydrochloride; 1,6-di[N₁,N₁′-.beta.-(p-methoxyphenyl) diguanido-N₅,N₅′]-hexane dihydrochloride; 1,6-di(N₁,N₁′-.alpha.-methyl-.beta.-phenyldiguanido-N₅,N₅′)-hexane dihydrochloride; 1,6-di(N₁,N₁′-p-nitrophenyldiguanido-N₅,N₅′)hexane dihydrochloride;. omega.: .omega.′-di-(N₁,N₁′-phenyldiguanido-N₅,N₅′)-di-n-propylether dihydrochloride; .omega:omega′-di(N ₁,N₁′-p-chlorophenyldiguanido-N₅,N₅′)-di-n-propylether tetrahydrochloride; 1,6-di(N ₁,N₁′-2,4-dichlorophenyldiguanido-N₅,N₅′)hexane tetrahydrochloride; 1,6-di(N₁,N₁′-p-methylphenyldiguanido-N₅,N₅′)hexane dihydrochloride; 1,6-di(N₁,N₁′-2,4,5-trichlorophenyldiguanido-N₅,N₅′)hexane tetrahydrochloride; 1,6-di[N₁,N₁′-.alpha.-(p-chlorophenyl) ethyldiguanido-N₅,N₅′] hexane dihydrochloride;.omega.:.omega.′di(N₁, N₁′-p-chlorophenyldiguanido-N₅,N₅′)m-xylene dihydrochloride; 1,12-di(N₁,N₁′-p-chlorophenyldiguanido-N₅,N₅′) dodecane dihydrochloride; 1,10-di(N₁,N₁′-phenyldiguanido-N₅,N₅′)-decane tetrahydrochloride; 1,12-di(N ₁,N₁′-phenyldiguanido-N₅,N₅′) dodecane tetrahydrochloride; 1,6-di(N₁,N₁′-o-chlorophenyldiguanido-N₅,N₅′) hexane dihydrochloride; 1,6-di(N₁,N₁′-p-chlorophenyldiguanido-N₅,N₅′)-hexane tetrahydrochloride; ethylene bis (1-tolyl biguanide); ethylene bis (p-tolyl biguanide); ethylene bis(3,5-dimethylphenyl biguanide); ethylene bis(p-tert-amylphenyl biguanide); ethylene bis(nonylphenyl biguanide); ethylene bis (phenyl biguanide); ethylene bis (N-butylphenyl biguanide); ethylene bis (2,5-diethoxyphenyl biguanide); ethylene bis(2,4-dimethylphenyl biguanide); ethylene bis(o-diphenylbiguanide); ethylene bis(mixed amyl naphthyl biguanide); N-butyl ethylene bis(phenylbiguanide); trimethylene bis(o-tolyl biguanide); N-butyl trimethylene bis(phenyl biguanide); and the corresponding pharmaceutically acceptable salts of all of the above such as the acetates; gluconates; hydrochlorides; hydrobromides; citrates; bisulfites; fluorides; polymaleates; N-coconutalkylsarcosinates; phosphites; hypophosphites; perfluorooctanoates; silicates; sorbates; salicylates; maleates; tartrates; fumarates; ethylenediaminetetraacetates; iminodiacetates; cinnamates; thiocyanates; arginates; pyromellitates; tetracarboxybutyrates; benzoates; glutarates; monofluorophosphates; and perfluoropropionates, and mixtures thereof. Preferred antimicrobials from this group are 1,6-di-(N₁,N₁′-phenyldiguanido-N₅,N₅′)-hexane tetrahydrochloride; 1,6-di(N₁,N₁′-o-chlorophenyldiguanido-N₅,N₅′)-hexane dihydrochloride; 1,6-di(N₁,N₁′-2,6-dichlorophenyldiguanido-N₅,N₅′)hexane dihydrochloride; 1,6-di(N₁,N₁′-2,4-dichlorophenyldiguanido-N₅,N₅′)hexane tetrahydrochloride; 1,6-di[N₁,N₁′-.alpha.-(p-chlorophenyl)ethyldiguanido-N₅,N₅′] hexane dihydrochloride;.omega.:.omega.′di(N₁, N₁′-p-chlorophenyldiguanido-N₅,N₅′)m-xylene dihydrochloride; 1,12-di(N₁,N₁′-p-chlorophenyldiguanido-N₅,N₅′) dodecane dihydrochloride; 1,6-di(N₁,N₁′-o-chlorophenyldiguanido-N₅,N₅′) hexane dihydrochloride; 1,6-di(N₁,N₁′-p-chlorophenyldiguanido-N₅,N₅′)-hexane tetrahydrochloride; and mixtures thereof; more preferably, 1,6-di(N₁,N₁′-o-chlorophenyldiguanido-N₅,N₅′)-hexane dihydrochloride; 1,6-di(N₁,N₁′-2,6-dichlorophenyldiguanido-N₅,N₅′)hexane dihydrochloride; 1,6-di(N₁,N₁′-2,4-dichlorophenyldiguanido-N₅,N₅′)hexane tetrahydrochloride; 1,6-di[N₁,N₁′-.alpha.-(p-chlorophenyl) ethyldiguanido-N₅,N₅′] hexane dihydrochloride;.omega.:.omega.′di(N₁, N₁′-p-chlorophenyldiguanido-N₅,N₅′)m-xylene dihydrochloride; 1,12-di(N₁,N₁′-p-chlorophenyldiguanido-N₅,N₅′) dodecane dihydrochloride; 1,6-di(N₁,N₁′-o-chlorophenyldiguanido-N₅,N₅′) hexane dihydrochloride; 1,6-di(N₁,N₁′-p-chlorophenyldiguanido-N₅,N₅′)-hexane tetrahydrochloride; and mixtures thereof. As stated hereinbefore, the bis biguanide of choice is chlorhexidine its salts, e.g., digluconate, dihydrochloride, diacetate, and mixtures thereof.

The surfactants, when added to the antimicrobials tend to provide improved antimicrobial action. This is especially true for the siloxane surfactants, and especially when the siloxane surfactants are combined with the chlorhexidine antimicrobial actives.

Chelators, e.g., ethylenediaminetetraacetic acid (EDTA), hydroxyethylene-diaminetriacetic acid, diethylenetriaminepentaacetic acid, and other aminocarboxylate chelators, and mixtures thereof, and their salts, and mixtures thereof, can optionally be used to increase antimicrobial and preservative effectiveness against Gram-negative bacteria, especially Pseudomonas species. Although sensitivity to EDTA and other aminocarboxylate chelators is mainly a characteristic of Pseudomonas species, other bacterial species highly susceptible to chelators include Achromobacter, Alcaligenes, Azotobacter, Escherichia, Salmonella, Spirillum, and Vibrio. Other groups of organisms also show increased sensitivities to these chelators, including fungi and yeasts. Furthermore, aminocarboxylate chelators can help, e.g., maintaining product clarity, protecting fragrance and perfume components, and preventing rancidity and off odors.

Although these aminocarboxylate chelators may not be potent biocides in their own right, they function as potentiators for improving the performance of other antimicrobials/preservatives in the compositions of the present invention. Aminocarboxylate chelators can potentiate the performance of many of the cationic, anionic, and nonionic antimicrobials/preservatives, phenolic compounds, and isothiazolinones, that are used as antimicrobials/preservatives in the composition of the present invention. Nonlimiting examples of cationic antimicrobials/preservatives potentiated by aminocarboxylate chelators in solutions are chlorhexidine salts (including digluconate, diacetate, and dihydrochloride salts), and Quaternium-15, also known as Dowicil 200, Dowicide Q, Preventol D1, benzalkonium chloride, cetrimonium, myristalkonium chloride, cetylpyridinium chloride, lauryl pyridinium chloride, and the like. Nonlimiting examples of useful anionic antimicrobials/preservatives which are enhanced by aminocarboxylate chelators are sorbic acid and potassium sorbate. Nonlimiting examples of useful nonionic antimicrobials/preservatives which are potentiated by aminocarboxylate chelators are DMDM hydantoin, phenethyl alcohol, monolaurin, imidazolidinyl urea, and Bronopol (2-bromo-2-nitropropane-1,3-diol).

Examples of useful phenolic antimicrobials/preservatives potentiated by these chelators are chloroxylenol, phenol, tert-butyl hydroxyanisole, salicylic acid, resorcinol, and sodium o-phenyl phenate. Nonlimiting examples of isothiazolinone antimicrobials/preservatives which are enhanced by aminocarboxylate chelators are Kathon®, Proxel® and Promexal®.

The optional chelators are present in the compositions of this invention at levels of, typically, from about 0.01% to about 0.3%, more preferably from about 0.02% to about 0.1%, most preferably from about 0.02% to about 0.05% by weight of the usage compositions to provide antimicrobial efficacy in this invention.

Free, uncomplexed aminocarboxylate chelators are required to potentiate the efficacy of the antimicrobials. Thus, when excess alkaline earth (especially calcium and magnesium) and transitional metals (iron, manganese, copper, and others) are present, free chelators are not available and antimicrobial potentiation is not observed. In the case where significant water hardness or transitional metals are available or where product esthetics require a specified chelator level, higher levels may be required to allow for the availability of free, uncomplexed aminocarboxylate chelators to function as antimicrobial/preservative potentiators.

13. Silicone Component

The fabric softening compositions herein optionally contain an aqueous emulsion of a predominantly linear polydialkyl or alkyl aryl siloxane in which the alkyl groups can have from one to five carbon atoms and can be wholly, or partially, fluoridated. These siloxanes act to provide improved fabric benefits and reduce sudsing in processing. Suitable silicones are polydimethyl siloxanes having a viscosity, at 25° C., of from about 100 to about 100,000 centistokes, preferably from about 1,000 to about 12,000 centistokes. In some applications as low as 1 centistoke materials are preferred.

The fabric softening compositions herein can contain from about 0.1% to about 10%, of the silicone component.

14. Thickening Agent

Optionally, the fabric softening compositions herein contain from 0% to about 3%, preferably from about 0.01% to about 2%, of a thickening agent. Examples of suitable thickening agents include: cellulose derivatives, synthetic high molecular weight polymers (e.g., carboxyvinyl polymer and polyvinyl alcohol), and cationic guar gums.

The cellulosic derivatives that are functional as thickening agents herein can be characterized as certain hydroxyethers of cellulose, such as Methocel, marketed by Dow Chemicals, Inc.; also, certain cationic cellulose ether derivatives, such as Polymer JR-125, JR-400, and JR-30M, marketed by Union Carbide.

Other effective thickening agents are cationic guar gums, such as Jaguar Plus, marketed by Stein Hall, and Gendrive 458, marketed by General Mills.

Preferred thickening agents herein are selected from the group consisting of methyl cellulose, hydroxypropyl methylcellulose, hydroxybutyl methylcellulose, or mixtures thereof, said cellulosic polymer having a viscosity in 2% aqueous solution at 20C of from about 15 to about 75,000 centipoises.

15. Soil Release Agent

In the present invention, an optional soil release agent may be added. The addition of the soil release agent may occur in combination with the premix, in combination with the acid/water seat, before or after electrolyte addition, or after the final composition is made. The softening composition prepared by the process of the present invention herein can contain from 0% to about 10%, preferably from 0.2% to about 5%, of a soil release agent. Preferably, such a soil release agent is a polymer. Polymeric soil release agents useful in the present invention include copolymeric blocks of terephthalate and polyethylene oxide or polypropylene oxide, and the like.

A preferred soil release agent is a copolymer having blocks of terephthalate and polyethylene oxide. More specifically, these polymers are comprised of repeating units of ethylene terephthalate and polyethylene oxide terephthalate at a molar ratio of ethylene terephthalate units to polyethylene oxide terephthalate units of from 25:75 to about 35:65, said polyethylene oxide terephthalate containing polyethylene oxide blocks having molecular weights of from about 300 to about 2000. The molecular weight of this polymeric soil release agent is in the range of from about 5,000 to about 55,000.

Another preferred polymeric soil release agent is a crystallizable polyester with repeat units of ethylene terephthalate units containing from about 10% to about 15% by weight of ethylene terephthalate units together with from about 10% to about 50% by weight of polyoxyethylene terephthalate units, derived from a polyoxyethylene glycol of average molecular weight of from about 300 to about 6,000, and the molar ratio of ethylene terephthalate units to polyoxyethylene terephthalate units in the crystallizable polymeric compound is between 2:1 and 6:1. Examples of this polymer include the commercially available materials Zelcon 4780 (from Dupont) and Milease T (from ICI).

Highly preferred soil release agents are polymers of the generic formula:

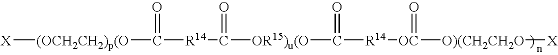

in which each X can be a suitable capping group, with each X typically being selected from the group consisting of H, and alkyl or acyl groups containing from about 1 to about 4 carbon atoms. p is selected for water solubility and generally is from about 6 to about 113, preferably from about 20 to about 50. u is critical to formulation in a liquid composition having a relatively high ionic strength. There should be very little material in which u is greater than 10. Furthermore, there should be at least 20%, preferably at least 40%, of material in which u ranges from about 3 to about 5.

The R¹⁴ moieties are essentially 1,4-phenylene moieties. As used herein, the term “the R¹⁴ moieties are essentially 1,4-phenylene moieties” refers to compounds where the R¹⁴ moieties consist entirely of 1,4-phenylene moieties, or are partially substituted with other arylene or alkarylene moieties, alkylene moieties, alkenylene moieties, or mixtures thereof. Arylene and alkarylene moieties which can be partially substituted for 1,4-phenylene include 1,3-phenylene, 1,2-phenylene, 1,8-naphthylene, 1,4-naphthylene, 2,2-biphenylene, 4,4-biphenylene, and mixtures thereof. Alkylene and alkenylene moieties which can be partially substituted include 1,2-propylene, 1,4-butylene, 1,5-pentylene, 1,6-hexamethylene, 1,7-heptamethylene, 1,8-octamethylene, 1,4-cyclohexylene, and mixtures thereof.

For the R¹⁴ moieties, the degree of partial substitution with moieties other than 1,4-phenylene should be such that the soil release properties of the compound are not adversely affected to any great extent. Generally the degree of partial substitution which can be tolerated will depend upon the backbone length of the compound, i.e., longer backbones can have greater partial substitution for 1,4-phylene moieties. Usually, compounds where the R¹⁴ comprise from about 50% to about 100% 1,4-phenylene moieties (from 0% to about 50% moieties other than 1,4-phenylene) have adequate soil release activity. For example, polyesters made according to the present invention with a 40:60 mole ratio of isophthalic (1,3-phenylene) to terephthalic (1,4-phenylene) acid have adequate soil release activity. However, because most polyesters used in fiber making comprise ethylene terephthalate units, it is usually desirable to minimize the degree of partial substitution with moieties other than 1,4-phenylene for best soil release activity. Preferably, the R¹⁴ moieties consist entirely of (i.e., comprise 100%) 1,4-phenylene moieties, i.e., each R¹⁴ moiety is 1,4-phenylene.

For the R¹⁵ moieties, suitable ethylene or substituted ethylene moieties include ethylene, 1,2-propylene, 1,2-butylene, 1,2-hexylene, 3-methoxy-1,2-propylene, and mixtures thereof. Preferably, the R¹⁵ moieties are essentially ethylene moieties, 1,2-propylene moieties, or mixtures thereof. Inclusion of a greater percentage of ethylene moieties tends to improve the soil release activity of compounds. Surprisingly, inclusion of a greater percentage of 1,2-propylene moieties tends to improve the water solubility of compounds.

Therefore, the use of 1,2-propylene moieties or a similar branched equivalent is desirable for incorporation of any substantial part of the soil release component in the liquid fabric softener compositions. Preferably, from about 75% to about 100%, are 1,2-propylene moieties.

The value for each p is at least about 6, and preferably is at least about 10. The value for each n usually ranges from about 12 to about 113. Typically the value for each p is in the range of from about 12 to about 43.

A more complete disclosure of soil release agents is contained in U.S. Pat. No. 4,661,267, Decker, Konig, Straathof, and Gosselink, issued Apr. 28, 1987; U.S. Pat. No. 4,711,730, Gosselink and Diehl, issued Dec. 8, 1987; U.S. Pat. No. 4,749,596, Evans, Huntington, Stewart, Wolf, and Zimmerer, issued Jun. 7, 1988; U.S. Pat. No. 4,818,569, Trinh, Gosselink, and Rattinger, issued Apr. 4, 1989; U.S. Pat. No. 4,877,896, Maldonado, Trinh, and Gosselink, issued Oct. 31, 1989; U.S. Pat. No. 4,956,447, Gosselink et al., issues Sep. 11, 1990; and U.S. Pat. No. 4,976,879, Maldonado, Trinh, and Gosselink, issued Dec. 11, 1990, all of said patents being incorporated herein by reference.

These soil release agents can also act as scum dispersants.

16. Scum Dispersant

In the present invention, a premix can be combined with an optional scum dispersant, other than the soil release agent, and heated to a temperature at or above the melting point(s) of the components.

The preferred scum dispersants herein are formed by highly ethoxylating hydrophobic materials. The hydrophobic material can be a fatty alcohol, fatty acid, fatty amine, fatty acid amide, amine oxide, quaternary ammonium compound, or the hydrophobic moieties used to form soil release polymers. The preferred scum dispersants are highly ethoxylated, e.g., more than about 17, preferably more than about 25, more preferably more than about 40, moles of ethylene oxide per molecule on the average, with the polyethylene oxide portion being from about 76% to about 97%, preferably from about 81% to about 94%, of the total molecular weight.

The level of scum dispersant is sufficient to keep the scum at an acceptable, preferably unnoticeable to the consumer, level under the conditions of use, but not enough to adversely affect softening. For some purposes it is desirable that the scum is nonexistent. Depending on the amount of anionic or nonionic detergent, etc., used in the wash cycle of a typical laundering process, the efficiency of the rinsing steps prior to the introduction of the compositions herein, and the water hardness, the amount of anionic or nonionic detergent surfactant and detergency builder (especially phosphates and zeolites) entrapped in the fabric (laundry) will vary. Normally, the minimum amount of scum dispersant should be used to avoid adversely affecting softening properties. Typically scum dispersion requires at least about 2%, preferably at least about 4% (at least 6% and preferably at least 10% for maximum scum avoidance) based upon the level of softener active. However, at levels of about 10% (relative to the softener material) or more, one risks loss of softening efficacy of the product especially when the fabrics contain high proportions of nonionic surfactant which has been absorbed during the washing operation.

Preferred scum dispersants are: Brij 700; Varonic U-250; Genapol T-500, Genapol T-800; Plurafac A-79; and Neodol 25-50.

17. Odor Control Agents Odor control agents are agents that eliminate odors on fabrics and/or prevent the formation of odor on fabrics while fabrics are in storage or use between cleaning or fabric care treatments. Typical odor control agents include cyclodextrin, low molecular weight polyols, metal salts, carbonate salts, bicarbonate salts, anti-oxidants, and select enzymes can all have odor control properties. Many of these odor control agents are describe more fully in U.S. application Ser. No. 09/805,099 filed Sep. 13, 2001 by Smith et al. When incorporating an odor control agent in the present invention it is typical to use about 0.001% to about 10% of the odor control agent and preferably from about 0.001% to about 5% of the odor control agent; in the case of enzymes this level refers to the commercial preparation rather than the active compounds as in the case of all other odor control agents.

18. Other Optional Ingredients

The present invention can include optional components conventionally used in textile treatment compositions, for example, short chain alcohols such as optical brighteners, opacifiers, surfactants, stabilizers such as guar gum and polyethylene glycol, anti-shrinkage agents, fabric crisping agents, spotting agents, germicides, fungicides, anti-oxidants such as butylated hydroxy toluene, anti-corrosion agents, and the like.

### II. Methods of Use

A faric care composition based on mixed actives comprising a PFSA and a FSCA that primarily offers the benefits of fabric softening can also provide optional benefits including wrinkle control, color care, and/or improved freshness.

The compositions and articles of the present invention which contain a fabric wrinkle control agent can be used to treat fabrics, garments, household fabrics, e.g. curtains, bed spreads, pillowcases, table clothes, napkins, and the like to remove or reduce, undesirable wrinkles, provide color care and/ or improve freshness in addition to the primary fabric softening benefit provided by the present compositions by use of the methods disclosed herein. The benefit of wrinkle control includes the benefits of fabrics which appear smoother after treatment and have less wrinkles and/or fabrics acquiring the the ability to resist reformation of wrinkles on storage, in-use or when left unattended in a dryer or clothes basket after treatment. Additionally wrinkle control benefits can include the benefit of making fabrics easier to iron after treatment either because there are less wrinkles after treatment and/or because it takes less force to remove wrinkles after treatment. Color care includes the benefit of improvements in the appearance of color after treatment and/or maintaining a better color appearance over time that is closer to the orignal color of the garment or the color of the garment when treatment with the present composition began. Improved freshness includes the benefits of delivering a higher than normal pleasant odor, maintaining a pleasant odor on fabrics for a longer than normal or expected time, removal of malodorants on fabrics, and/or preventing fabrics from picking up malodorants in use or storage.

Fabric Treatment with the Present Compositions

Fabrics can be treated by contacting fabrics with an aqueous bath containing an effective level of the present composition. The aqueous bath typically has a temperature from about A method of treating fabrics comprises the step of contacting the fabrics in an aqueous medium that typically has a temperature of from about 15° C. to about 60° C. containing the above softener compounds or softening composition

A typical immersion method for treating compositions of the present invention involves dispensing an effective amount of composition into the rinse cycle of a domestic or commercial washing machine. When fabrics or fibers are treated by immersion these are typically contacted with an effective amount, generally from about 5 ml to about 500 ml (per 3.5 kg of fiber or fabric being treated), or more preferably from about 20 ml to about 200 mL of the present composition compositions herein in an aqueous bath. contains from about 10 ppm to about 1000 ppm of the fabric softening actives PFSA+FSCA herein when used in the typical domestic or commercial immersion process. A method of treating fabrics comprises the step of contacting the fabrics in an aqueous medium that typically has a temperature of from about 15° C. to about 60° C. containing the above softener compounds or softening composition

The compositions of the present invention are can be used in the rinse cycle of the conventional automatic laundry operations.

Fabrics or fibers are contacted with an effective amount, generally from about 20 ml to about 300 ml (per 3.5 kg of fiber or fabric being treated), of the compositions herein in an aqueous bath. Of course, the amount used is based upon the judgment of the user, depending on concentration of the softening materials, PFSA+FSCA, fiber or fabric type, degree of performance desired, and the like. Typically, from about 20 ml to about 300 ml of 9% to 40% dispersion of the softening materials PFSA+FSCA are typically used in a 25 gallon laundry rinse bath to soften and provide antistatic benefits to a 3.5 kg load of mixed fabrics. Preferably, the rinse bath contains from about 20 ppm to about 1000 ppm of the fabric softening materials PFSA+FSCA herein when used in conventional domestic processes.

While fabrics are typically treated with the present composition by immersion, there are also other acceptable methods for contacting or treating fabrics with the present composition. For instance, another means of contacting fabrics with the aqeuous bath containing the present composition is by spraying or padding the aqueous bath containing the present composition onto fabrics. When spraying the present composition onto fabrics it is typical to dilute the composition such that the final aqueous bath comprises at least about 1 aliquot of the present composition to about 1000 aliquots of water; preferably about 1 aliquot of the present composition to about 100 aliquots of water, more preferably about 2 aliquots of the present composition to about 100 aliquots of water and even more preferably 6 aliquots of the present composition to about 100 aliquots of water and typically the final aqueous bath would comprise less than about 99 aliquots of the present composition to about 1 aliquot of water and preferably less than about 50 aliquots of the present composition to about 50 aliquots of water. For padding, the aqueous bath would be composed such that the final levels of actives would be typical of those used in a commercial mill.

A method of treating fabrics by immersion comprises the step of contacting the fabrics in an aqueous medium that typically has a temperature of from about 15° C. to about 60° C. containing the above softener compounds or softening composition

The compositions of the present invention are can be used in the rinse cycle of the conventional automatic laundry operations.

Fabrics or fibers are contacted with an effective amount, generally from about 20 ml to about 300 ml (per 3.5 kg of fiber or fabric being treated), of the compositions herein in an aqueous bath. Of course, the amount used is based upon the judgment of the user, depending on concentration of the softening materials, PFSA+FSCA, fiber or fabric type, degree of performance desired, and the like. Drying may be accomplished either by air drying or by contacting fabric with forced stream of cool to hot air as in a domestic or commercial drying process or for instance by using a hand held dryer or mechanical fan.

### III. Article of Manufacture

The present articles of manufacture comprise (1) a container, (2) a composition (3) a means of dispensing the composition from the container, (4) optionally a package that encompasses elements 1, 2, 3, and optional 5, and (5) optionally, but preferably a set of instructions that are typically in association with the container or packaging. The set of instructions typically communicates to the consumer of the present articles to dispense the composition in an amount effective to provide a solution to problems involving, and/or provision of a benefit related to, those selected from the group improved absorbency, wrinkle control, color care, and/or improved freshness. It is important that the consumer of the present article be aware of these benefits, since otherwise the consumer would not know that the composition would solve these problems or combination of problems and/or provide these benefits or combination of benefits.

The article of manufacture can also comprise the composition of the present invention in a container in association with a set of instructions to use the composition in an amount effective to provide a solution to problems involving and/or provision of a benefit related to those selected from the group consisting of: wrinkle control, color care, and/or improved freshness. It is important that the consumer be aware of these additional benefits, since otherwise the consumer would not know that the composition would solve these problems and /or provide these benefits.

As used herein, the phrase “in association with” means the set of instructions are either directly printed on the container itself or presented in a separate manner including, but not limited to, a brochure, print communication, electronic communication, broadcast communication and/or verbal communication, so as to communicate the set of instructions to a consumer of the article of manufacture. The set of instructions preferably comprises the instruction to add an effective amount of the composition to an aqueous bath and contact with fabrics to provide additional benefits including wrinkle control, color care, and/or improved freshness.

The set of instructions of the present articles can comprise the instruction or instructions to achieve the benefits discussed herein by carrying the methods of compositions of the present invention.

Additional Instruction for Wrinkle Control Benefits

When it is desired to dewrinkle fabrics the following additional instructions can be used. Typically it is preferred to use larger doses of the present composition when wrinkle benefits are desired. For instance, in the domestic process at least more than about 30 mL, preferably more than about 50 mLs and most preferably more than about 70 mLs of the present composition is used to treat each 3.5 kg of fabric in the aqueous bath. In terms of rinse concentration of fabric softener active, to provide wrinkle benefits it is preferably to have at least 50 ppm total PFSA+FSCA; more preferably at least about 90 ppm; even more preferably at least about 180 ppm; and most preferably about 270 ppm total PFSA+FSCA in the aqueous bath in order to provide wrinkle control benefits. Not to be bound by theory, but using higher doses imparts more lubricity to fabrics and fibers resulting in easier removal of wrinkles.

To enhance wrinkle removal, fabrics are mechanically and/or manually manipulated before the drying process is completed, including manipulation by hand, by iron, or by machine. When manipulating fabrics by hand to remove wrinkles, fabrics are manipulated while wet or still damp after partial drying. Not to be bound by theory, but water plasticizes fibers and yarns and breaks hydrogen bonds between fibers and fibrils, thus making wrinkles easier to manipulate out of fabrics. There are several manipulations that can be employed to aid in winkle control. The garments can be stretched both perpendicular and parallel to the wrinkle (or at any angle around the wrinkle) which will help to ease the wrinkle out of the clothing. Stretching the fabrics in a direction perpendicular to the line of the wrinkle is especially helpful in removing the wrinkle from clothing. The fabrics can also be smoothed using the hands with pressing and gliding motions similar to those employed with an iron. The stretching and/or smoothing procedure can be performed with the garment hung vertically, e.g., on a clothes hanger or spread on a horizontal surface, such as, a bed, an ironing board, a table surface, and the like. Another method to loosen wrinkles after treating involves shaking out fabrics with enough energy to loosen wrinkles, in some cases it may be necessary to impart enough energy to cause the fabric to make a snapping noise or motion. The wrinkles could also be manipulated out of the fabric using an implement designed to help smooth the fabrics. Such an implement would be useful in preventing contacts between hands and wrinkle controlling composition, if desired. Many fabrics or garments also contain bends in the fabrics, often termed creases or pleats, that are desireable. Such creases or pleats are often found on the front of pant legs and the sides of sleeves. These can be reinforced while the garment is being shaped to preseve the crease. Creases are reinforced by applying pressure usually by pinching the fabric either with hands or an implement and pulling the crease through the pressure point or by hanging the garment so that it folds at the crease and reinforces it with the pressure of gravity. The fabric should then be laid out flat to dry or hung on a hanger or with some other apparatus such that the fabric will remain smooth while drying. Weights can be attached to critical points on fabrics and garments to aid in maintaining smooth appearance during drying. When manual manipulations will be employed to control wrinkles that are hanging, it is optional, but convient and preferable to use a swivel clothes hanger A swivel clothes hanger has a frame that can be rotated around the stem of the hook. A fabric hung on said swivel hanger can be oriented in many directions.

When mechanical means such as a domestic or commercial dryer is used to dry fabrics, the following instructions are useful for controlling wrinkles. Preferably, for optimum dewrinkling benefit, the temperature profile inside the dryer ranges from about 40° C. to about 80° C., more preferably from about 50° C. to about 70° C. The preferred length of the drying cycle is from about 15 to about 60 minutes, more preferably from about 20 to about 45 minutes. Fabric should be removed as soon as possible, preferably immediately, following the drying cycle and arranged to maintain the smooth appearance of the fabrics with for instance, but not limited to, arranging sleeves, collars, pant legs so these are smooth and not twisted in any way, hanging the fabric on a hanger, laying the fabric flat on a or putting the fabric to its natural use to maintain its appearance e.g. hang curtains, put bed linens on the bed, put table linens on the table. Preferably the fabric will not be folded and stored until it is completely dry. It is preferable to remove fabrics before these are completely dried if it is desired to use manual manipulation as above to improve the smoothness appearance compositions using a swivel clothes hanger.

Additional Instructions for Color Care Benefits

Typically, users of compositions of the present invention will perceive the use of the composition for softening of fabrics. Normally users of compositions of the present invention will not think that such compositions can provide color care benefits in terms of color maintenance and/or prevention of color loss or color restoration unless the attention of the use is drawn to these benefits. Therefore, it is important, to make the user aware of such benefits, so that the user can derive the full benefit of the present composition.

Also, by providing the user with additional instructions in combination with the composition, the user can dervie a suprising improvement in color care benefits from compositions of the present invention. Typically, fabric softening can be derived from composition of the present invention through the use of about 1 g (fabric softener active) per kg of fabric. Now it is suprisingly found that compositions of the present invention provide improved benefits in color care by using at least abou 3 g (fabric softener active) per kg of fabric. Preferably the user should be instructed to use about 3.3 g of active per kg of fabric to about 14 g of active per kg of fabric; more preferably the use is instructed to use about 4 g of active per kg of fabric; even more preferably about 5 g active to about 12 kg of fabric; and still more preferably about 6 g of active per kg of fabric to about 10 g of active per kg of fabric.

Further instructions for the protection of fabric color include physical tasks the user can perform during the wash process to prevent fabric color appearance losses. For instance, inverting a fabric when possible (e.g. with clothes, shirts, pants, sweaters) before adding the fabric to the wash to reduce abrasion at the surface that will be shown. Another task includes reducing the load size vs. water volume to reduce likelihood of fabric to fabric rubbing and abrasion.

Additional Instructions for Odor Control Benefits.

Typically the user would not expect odor control benefits related to in-wear or in-use malodor control from such a product. When optional odor control technologies are incorporated, instructing the consumer that such benefits are available is necessary to allow the user to derive the full benefits associated with the product.

### EXAMPLES

The following are non-limiting examples of compositions made with high-fluid DEEDMAC having different monoester/diester ratios.

| Compound | Formula 2A | Formula 2B |
|---|---|---|
| high-fluid DEEDMAC¹ | 12.35 | 0 |
| (⅙ Mono-ester/Diester ratio) | | |
| high-fluid DEEDMAC | 0 | 12.35 |
| (1/10 Mono-ester/Diester ratio) | | |
| soft-tallow DEEDMAC² | 12.35 | 12.35 |
| DTPA³ | 0.007 | 0.007 |
| DC 2310⁴ | 0.015 | 0.015 |
| HCl | 0.0139 | 0.0139 |
| CaCl₂ | 0.545 | 0.545 |
| Perfume | 1.28 | 1.28 |
| HOE 4060⁵ | 0.25 | 0.25 |
| NH₄Cl | 0.1 | 0.1 |
| Dye | 0.0022 | 0.0022 |
| Water | balance | balance |

1. Dicanola-oylethylester dimethyl ammonium chloride
2. Ditallowoylethylester dimethyl ammonium chloride
3. Diethylenetriamine penta-acetic acid.
4. Silicone emulsion used for suds suppresion available from Dow coming.
5. Block copolymer based on terephthalate and propylene glycol available from Clariant.

Viscosity Stability

Eight week viscosity stability shows generally improved viscosity stability for Formula 2A vs. 2B on storage, particularly at the higher temperature where highly fluid actives are most difficult to stabilize.

Dispersed Phase Volume

Percent dispersed phase volume (% DPV) is another parameter for understanding product stability. Generally, the lower the % DPV the more likely the product will demonstrate stability over time and under stress conditions such as storage under non-ambient temperature conditions. Not to be bound by theory, but the lower the % DPV the lower the opportunity for vesicles to interact reducing the liklihood of instability behaviors such as creaming, separation, coalescence, and increases in viscosity The first step in measuring % DPV is to separate the composition using by centrifuging the composition (Beckman Optima™ L-70K Ultracentrifuge) for 16 hrs at 40,000 rpm. After centrifuging the total height split composition is measured as well as the height of the aqueous phase. The total volume of the composition as well as the volume of the aqueous phase are calculated and the % volume of aqueous phase is calculated. The % volume of the lipid phase is derived by subtraction. Formula 2A exhibited a %DPV significantly lower than the %DPV for Formula 2B.

What is claimed is:

1. A fabric softening composition comprising at least 10% of a fabric softening active system, wherein said fabric softening active system comprises at least 5% of a fabric softening active having an amine-based head group and a ratio of mono-tail groups to di-tail groups of from about 1:1 to about 1:10.

2. The composition of claim 1, wherein said ratio of mono-tail groups to di-tail groups is from about 1:1 to about 1:9.

3. The composition of claim 2, wherein said ratio of mono-tail groups to di-tail groups is from about 1:1 to about 1:6.

4. The composition of claim 3, wherein said ratio of mono-tail groups to di-tail groups is from about 1:3 to about 1:6.
